(19) United States
(12) Patent Application Publication
(10) Pub. No.: US 2022/0260719 A1
(43) Pub. Date: Aug. 18, 2022

(54) MEASURING APPARATUS AND MEASURING METHOD

(71) Applicant: NIPPON TELEGRAPH AND TELEPHONE CORPORATION, Tokyo (JP)

(72) Inventors: Hideyuki TSUBOI, Musashino-shi, Tokyo (JP); Hideki TOSHINAGA, Musashino-shi, Tokyo (JP); Kazuto GOTO, Musashino-shi, Tokyo (JP); Satoshi KUROSAKI, Musashino-shi, Tokyo (JP); Kota ITO, Musashino-shi, Tokyo (JP); Mizuki SUGA, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 17/628,817

(22) PCT Filed: Jul. 24, 2019
(86) PCT No.: PCT/JP2019/028992

§ 371 Date: Jan. 20, 2022

(51) Int. Cl. G01S 17/894; G01S 7/48

(52) U.S. Cl. CPC G01S 17/894; G01S 7/4802

(57) ABSTRACT

A measurement device configured to move along a movement path and measure the position of an object in surroundings of the movement path includes: a measurement unit configured to measure the position of the object with a plurality of surfaces as measurement targets, the plurality of surfaces facing in directions different from each other; and a point group data generation unit configured to generate point group data of the object in surroundings of the movement path by using positional data representing the position of the object measured by the measurement unit.

### TECHNICAL FIELD

The present invention relates to a measurement device and a measurement method.

### BACKGROUND ART

A mobile mapping system (MMS) performs measurement and generates three-dimensional data (for example, point group data) of an object in surroundings by using various measurement instruments mounted in combination on a vehicle while traveling on a road. The MMS includes a measurement instrument, such as a light detection and ranging or laser imaging detection and ranging (lidar), for performing measurement of a direction in which the object exists and a distance from the system to the object (refer to Non-Patent Literature 1, for example). Conventionally, for example, effective maintenance and inspection of a degradation situation of an outdoor infrastructure facility such as a communication utility pole have been performed by analyzing collected three-dimensional data (refer to Patent Literature 1 and Non-Patent Literature 2, for example).

### CITATION LIST

### Patent Literature

Patent Literature 1: Japanese Patent No. 6531051

### Non-Patent Literature

Non-Patent Literature 1: Masaki Waki, Takashi Goto, Kazunori Katayama, “Tutorial Paper: 3D Facility Management Technology Using MMS (Mobile Mapping System)”, communication society magazine, No. 45 Summer, pp. 39 to 45, Institute of Electronics, Information and Communication Engineers, 2018
Non-Patent Literature 2: “Mitsubishi mobile mapping system: high-accuracy GPS movement measurement device”, product brochure, Mitsubishi Electric Corporation, March 2016
Non-Patent Literature 3: “Product safety solution that supports i-Automation! 44: Laser scanner is reflective but safe”, [online], Omron, [Jul. 8, 2019 search], the Internet <URL: https://www.fa.omron.co.jp/solution/sysmac/safetynavigator/hint/44.html>

### SUMMARY OF THE INVENTION

### Technical Problem

For example, a tree is a measurement object having a complicate shape. In a tree, a leaf growing at a position on the traveling direction side of the MMS or a side opposite thereto, in particular, grows in a direction in which a side surface thereof faces the MMS, in many cases. Typically, it is difficult to perform measurement at a narrow interval comparable to the thickness of a leaf of a tree, and thus it is difficult to measure all leaves growing with their side surfaces facing the MMS. Thus, in a tree, a region (hereinafter referred to as a “measurement insensible region”) in which measurement by the MMS is difficult is sometimes generated in ranges on the moving direction side of the MMS and the side opposite thereto, in particular. In this case, due to generation of the measurement insensible region, a measured tree width is potentially recognized as a width smaller than its actual width by an amount corresponding to the measurement insensible region.

When a building or the like is a measurement object, a region (hereinafter referred to as a “measurement impossible region”) that is a blind spot at which measurement cannot be performed, and a region (referred to as a “measurement low-accuracy region”) in which the accuracy of measurement decreases because the side surface is a surface nearly orthogonal to the traveling direction of the MMS are generated at positions on each side surface of the building in a view from the position of the MMS in some cases.

The present invention is intended to solve the above-described problem and provide a measurement device and a measurement method that are capable of reducing a region in which measurement is impossible and a region in which the accuracy of measurement decreases.

### Means for Solving the Problem

An aspect of the present invention is a measurement device configured to move along a movement path and measure the position of an object in surroundings of the movement path, the measurement device including: a measurement unit configured to measure the position of the object with a plurality of surfaces as measurement targets, the plurality of surfaces facing in directions different from each other; and a point group data generation unit configured to generate point group data of the object in surroundings of the movement path by using positional data representing the position of the object measured by the measurement unit.

Another aspect of the present invention is a measurement method of moving along a movement path and measuring the position of an object in surroundings of the movement path, the measurement method including: a measurement step of measuring the position of the object with a plurality of surfaces as measurement targets, the plurality of surfaces facing in directions different from each other; and a point group data generation step unit of generating point group data of the object in surroundings of the movement path by using positional data representing the position of the object measured by the measurement step.

### Effects of the Invention

According to the present invention, it is possible to reduce a region in which measurement is impossible and a region in which the accuracy of measurement decreases.

### BRIEF DESCRIPTION OF DRAWINGS

FIG. 1 is a schematic diagram illustrating the position of positional data acquisition by a conventional MMS.

FIG. 2 is a schematic diagram illustrating the position of positional data acquisition by the conventional MMS.

FIG. 3 is a schematic diagram illustrating the position of positional data acquisition by the conventional MMS.

FIG. 4 is a schematic diagram illustrating exemplary measurement by the conventional MMS.

FIG. 5 is a schematic diagram illustrating exemplary measurement by the conventional MMS.

FIG. 6 is a schematic diagram illustrating exemplary measurement by the conventional MMS.

FIG. 7 is a schematic diagram illustrating exemplary measurement by the conventional MMS.

FIG. 8 is a schematic diagram illustrating exemplary measurement by the conventional MMS.

FIG. 9 is a schematic diagram illustrating exemplary measurement by the conventional MMS.

FIG. 10 is a schematic diagram illustrating the relation between the distance to a measurement object and the interval of positional data acquisition positions.

FIG. 11 is a schematic diagram illustrating the size of a space measurable by the conventional MMS.

FIG. 12 is a schematic diagram illustrating a measurement insensible region when the measurement object is a tree.

FIG. 13 is a schematic diagram illustrating the measurement insensible region when the measurement object is a tree.

FIG. 14 is a schematic diagram illustrating the relation between the orientation of a leaf Lf and the direction of laser beam emission by a lidar.

FIG. 15 is a schematic diagram illustrating the relation between the orientation of the leaf Lf and the direction of laser beam emission by the lidar.

FIG. 16 is a schematic diagram illustrating the relation between the orientation of the leaf Lf and the direction of laser beam emission by the lidar.

FIG. 17 is a schematic diagram illustrating the relation between the orientation of the leaf Lf and the direction of laser beam emission by the lidar.

FIG. 18 is a schematic diagram illustrating the relation between the orientation of the leaf Lf and the direction of laser beam emission by the lidar.

FIG. 19 is a schematic diagram illustrating the relation between the orientation of the leaf Lf and the direction of laser beam emission by the lidar.

FIG. 20 is a schematic diagram illustrating a measurement impossible region and a measurement low-accuracy region when the measurement object is a building.

FIG. 21 is a schematic diagram illustrating the measurement impossible region and the measurement low-accuracy region when the measurement object is a building.

FIG. 22 is a schematic diagram illustrating the position of positional data acquisition by an MMS according to a first embodiment of the present invention.

FIG. 23 is a schematic diagram illustrating the position of positional data acquisition by the MMS according to the first embodiment of the present invention.

FIG. 24 is a schematic diagram illustrating the position of positional data acquisition by the MMS according to the first embodiment of the present invention.

FIG. 25 is a schematic diagram illustrating exemplary measurement by the MMS according to the first embodiment of the present invention.

FIG. 26 is a schematic diagram illustrating exemplary measurement by the MMS according to the first embodiment of the present invention.

FIG. 27 is a schematic diagram illustrating exemplary measurement by the MMS according to the first embodiment of the present invention.

FIG. 28 is a schematic diagram for description of the measurement insensible region when the measurement object is a tree.

FIG. 29 is a schematic diagram for description of the measurement insensible region when the measurement object is a tree.

FIG. 30 is a schematic diagram illustrating the relation between the orientation of the leaf Lf and the direction of laser beam emission by the lidar.

FIG. 31 is a schematic diagram illustrating the relation between the orientation of the leaf Lf and the direction of laser beam emission by the lidar.

FIG. 32 is a schematic diagram illustrating the relation between the orientation of the leaf Lf and the direction of laser beam emission by the lidar.

FIG. 33 is a bird's eye view of a leaf Lf and its surroundings, the leaf Lf growing in a measurement insensible region arL of a tree t.

FIG. 34 is a vertical cross-sectional view of the leaf Lf and its surroundings, the leaf Lf growing in the measurement insensible region arL of the tree t.

FIG. 35 is a horizontal view of the leaf Lf and its surroundings, the leaf Lf growing in the measurement insensible region arL of the tree t.

FIG. 36 is a bird's eye view of a leaf Lf and its surroundings, the leaf Lf growing in a measurement insensible region arR of the tree t.

FIG. 37 is a vertical cross-sectional view of the leaf Lf and its surroundings, the leaf Lf growing in the measurement insensible region arR of the tree t.

FIG. 38 is a horizontal bird's eye view of the leaf Lf and its surroundings, the leaf Lf growing in the measurement insensible region arR of the tree t.

FIG. 39 is a schematic diagram illustrating exemplary measurement by the MMS according to the first embodiment of the present invention.

FIG. 40 is a schematic diagram illustrating exemplary measurement by the MMS according to the first embodiment of the present invention.

FIG. 41 is a schematic diagram illustrating exemplary measurement by the MMS according to the first embodiment of the present invention.

FIG. 42 is a schematic diagram for description of the measurement impossible region and the measurement low-accuracy region when the measurement object is a building.

FIG. 43 is a schematic diagram for description of the measurement impossible region and the measurement low-accuracy region when the measurement object is a building.

FIG. 44 is a block diagram illustrating a functional configuration of an MMS 10 according to the first embodiment of the present invention.

FIG. 45 is a flowchart illustrating operation of the MMS 10 according to the first embodiment of the present invention.

FIG. 46 is a schematic diagram illustrating the configuration of a measurement unit 101 according to the first embodiment of the present invention.

FIG. 47 is a schematic diagram illustrating the configuration of the measurement unit 101 according to the first embodiment of the present invention.

FIG. 48 is a schematic diagram illustrating the configuration of a measurement unit 101-2 according to a modification of the first embodiment of the present invention.

FIG. 49 is a schematic diagram illustrating the configuration of the measurement unit 101-2 according to the modification of the first embodiment of the present invention.

FIG. 50 is a flowchart illustrating operation of a lidar Ls2 according to the modification of the first embodiment of the present invention.

FIG. 51 is a schematic diagram illustrating the configuration of a measurement unit 101-3 according to a modification of a second embodiment of the present invention.

FIG. 52 is a schematic diagram illustrating the position of positional data acquisition by an MMS according to the second embodiment of the present invention.

FIG. 53 is a schematic diagram illustrating the position of positional data acquisition by the MMS according to the second embodiment of the present invention.

FIG. 54 is a schematic diagram illustrating the position of positional data acquisition by the MMS according to the second embodiment of the present invention.

FIG. 55 is a schematic diagram illustrating exemplary measurement by the MMS according to the second embodiment of the present invention.

FIG. 56 is a schematic diagram illustrating exemplary measurement by the MMS according to the second embodiment of the present invention.

FIG. 57 is a schematic diagram illustrating exemplary measurement by the MMS according to the second embodiment of the present invention.

FIG. 58 is a schematic diagram for description of the measurement insensible region when the measurement object is a tree.

FIG. 59 is a schematic diagram for description of the measurement insensible region when the measurement object is a tree.

FIG. 60 is a schematic diagram illustrating the relation between the orientation of a leaf Lf and the direction of laser beam emission by a lidar Ls.

FIG. 61 is a schematic diagram illustrating the relation between the orientation of the leaf Lf and the direction of laser beam emission by the lidar Ls.

FIG. 62 is a schematic diagram illustrating the relation between the orientation of the leaf Lf and the direction of laser beam emission by the lidar Ls.

FIG. 63 is a schematic diagram illustrating exemplary measurement by the MMS according to the second embodiment of the present invention.

FIG. 64 is a schematic diagram illustrating exemplary measurement by the MMS according to the second embodiment of the present invention.

FIG. 65 is a schematic diagram illustrating exemplary measurement by the MMS according to the second embodiment of the present invention.

FIG. 66 is a schematic diagram for description of the measurement impossible region and the measurement low-accuracy region when the measurement object is a building.

FIG. 67 is a schematic diagram for description of the measurement impossible region and the measurement low-accuracy region when the measurement object is a building.

### DESCRIPTION OF EMBODIMENTS

First, a measurement method according to a conventional technology will be described below to facilitate understanding of description of embodiments of the present invention.

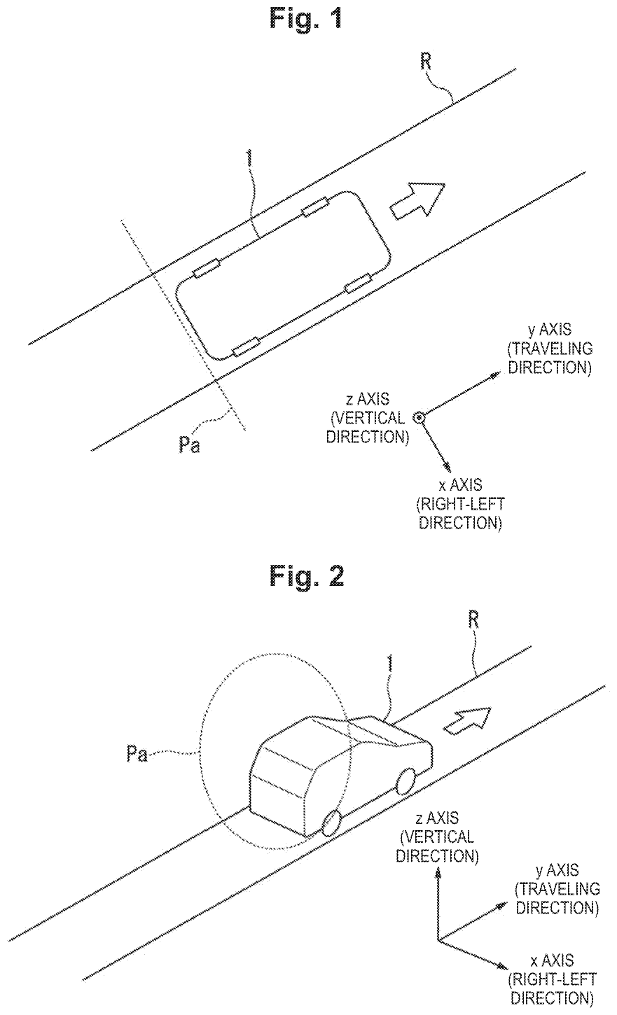

FIGS. 1 to 3 are each a schematic diagram illustrating the position of positional data acquisition by a conventional MMS. FIGS. 1 to 3 illustrate a horizontal view, a bird's eye view, and a vertical cross-sectional view, respectively, of a space in which a vehicle 1 exists at a time point, the MMS (not illustrated) being mounted on the vehicle 1.

A lidar (not illustrated) is mounted at a back part of the vehicle 1. The MMS measures, through the lidar, surroundings of a road R on which the vehicle 1 travels, and acquires data (hereinafter referred to as “positional data”) representing the position of an object that exists in surroundings of the road R. The MMS performs measurement in each direction (direction in the range of 360° of centered at the lidar) on a surface (hereinafter referred to as a “cross-section”) orthogonal to the traveling direction of the vehicle 1.

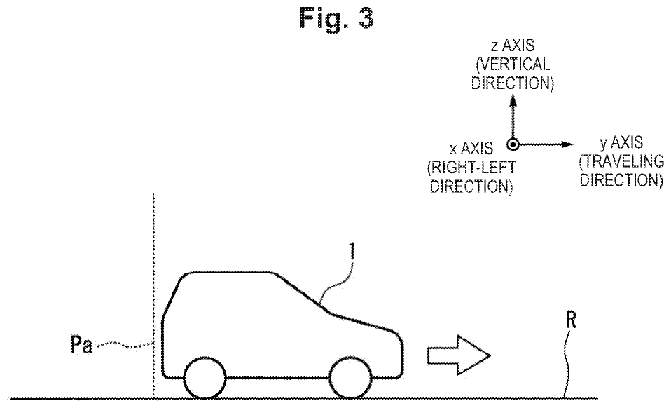

FIGS. 1 to 3 each illustrate positional data acquisition positions Pa as a set of acquisition positions of the positional data acquired by the lidar. As illustrated in FIG. 1, the positional data acquisition positions Pa in the horizontal view are positions on a line extending from the position of the back part of the vehicle 1 (which is the installation position of the lidar) in a direction orthogonal to the traveling direction of the vehicle 1. As illustrated in FIG. 2, the positional data acquisition positions Pa in the bird's eye view are positions on the circumference of a circle centered at the position of the back part of the vehicle 1. As illustrated in FIG. 3, the positional data acquisition positions Pa in the vertical cross-sectional view are positions on a line extending from the position of the back part of the vehicle 1 in the direction orthogonal to the traveling direction of the vehicle 1.

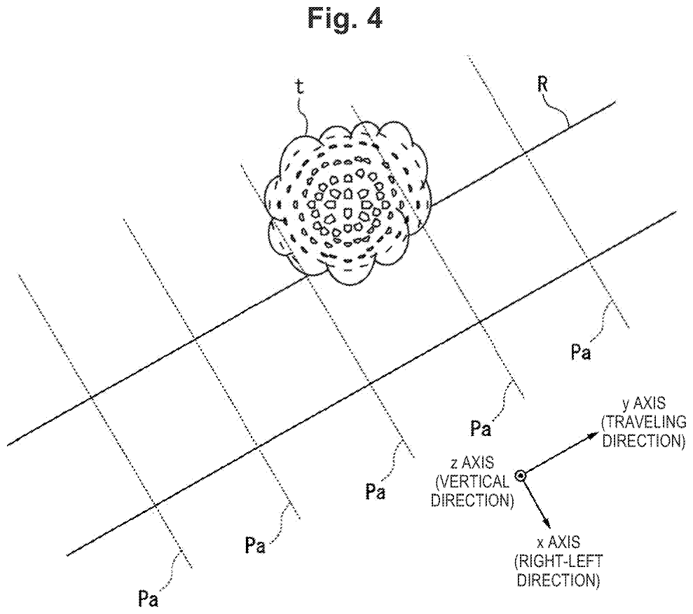

FIGS. 4 to 6 are each a schematic diagram illustrating exemplary measurement by the conventional MMS. FIGS. 4 to 6 illustrate a horizontal view, a bird's eye view, and a vertical cross-sectional view, respectively, of a space traveled by the vehicle 1 on which the MMS configured to measure surroundings of the road R is mounted.

The vehicle 1 travels on the road R at a constant speed. Accordingly, the MMS mounted on the vehicle 1 can acquire the positional data of an object that exists in surroundings of the road R at a constant interval. For example, as illustrated in FIGS. 4 to 6, one tree t exists on the left side of the road R with respect to the traveling direction of the vehicle 1. The MMS acquires the positional data of the tree t when passing by the tree t.

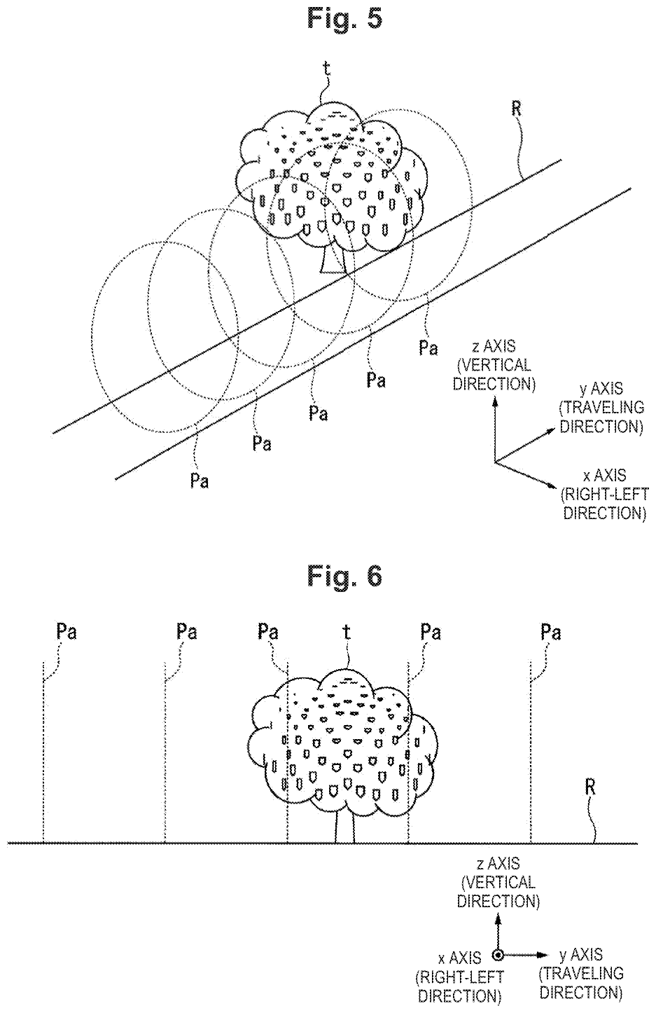

FIGS. 4 to 6 each illustrate all positional data acquisition positions Pa when the vehicle 1 travels on the road R. As illustrated in FIG. 4, the positional data acquisition positions Pa in the horizontal view are positions on respective lines extending in the direction orthogonal to the traveling direction of the vehicle 1 and arranged in parallel at an equal interval. In FIG. 4, two of the lines overlap the tree t. As illustrated in FIG. 5, the positional data acquisition positions Pa in the bird's eye view are positions on the circumferences of circles arranged at an equal interval in the traveling direction of the vehicle 1. As illustrated in FIG. 6, the positional data acquisition positions Pa in the vertical cross-sectional view are positions on respective lines extending in the direction orthogonal to the traveling direction of the vehicle 1 and arranged in parallel at an equal interval. Similarly to FIG. 4, two of the lines overlap the tree t in FIG. 6.

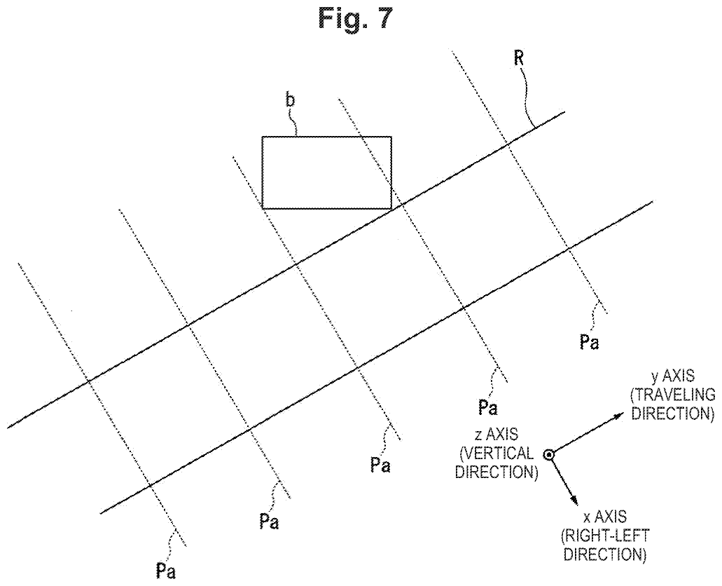

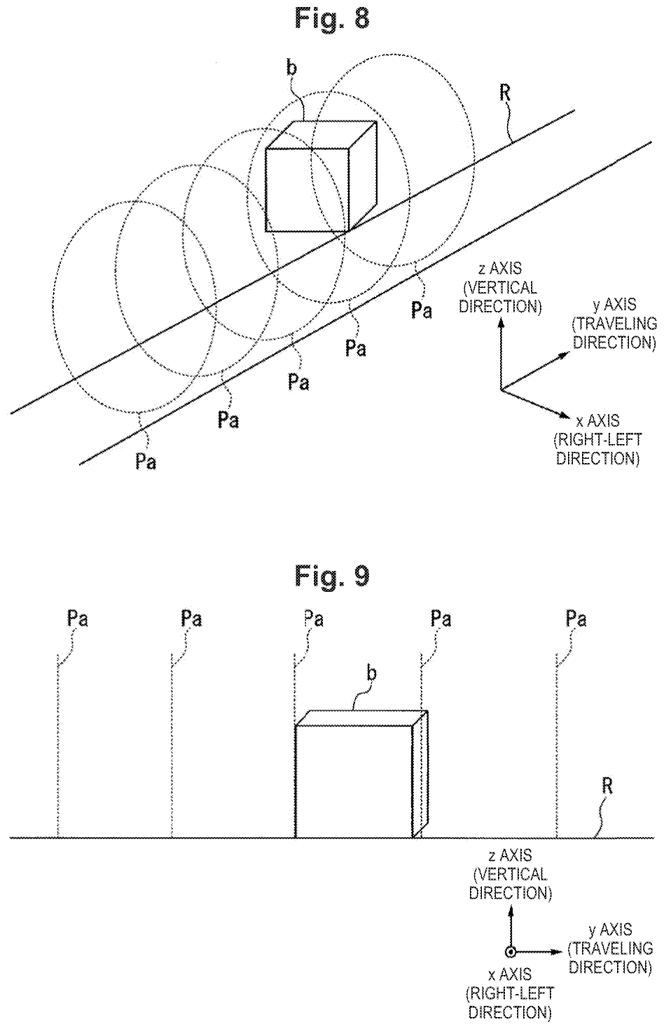

Similarly to FIGS. 4 to 6, FIGS. 7 to 9 are each a schematic diagram illustrating exemplary measurement by the conventional MMS. FIGS. 7 to 9 illustrate a horizontal view, a bird's eye view, and a vertical cross-sectional view, respectively, of a space traveled by the vehicle 1 on which the MMS configured to measure surroundings of the road R is mounted.

The vehicle 1 travels on the road R at a constant speed. Accordingly, the MMS mounted on the vehicle 1 can acquire the positional data of an object that exists in surroundings of the road R at a constant interval. For example, as illustrated in FIGS. 7 to 9, one building b exists on the left side of the road R with respect to the traveling direction of the vehicle 1. The MMS acquires the positional data of the building b when passing by the building b.

FIGS. 7 to 9 illustrate the positional data acquisition positions Pa when the vehicle 1 travels on the road R. As understood with reference to FIG. 7, a side surface of the building b on the left side is a blind spot when viewed from the position of the vehicle 1 passing by the building b along the road R, and no positional data acquisition positions Pa exist on the side surface. Thus, the side surface of the building b on the left side is a measurement impossible region when viewed from the position of the vehicle 1. In addition, as understood with reference to FIG. 7, a side surface of the building b on the right side is a surface nearly orthogonal to the traveling direction of the vehicle 1 when viewed from the position of the vehicle 1 passing by the building b along the road R, and thus, a smaller number of positional data acquisition positions Pa exist (in other words, a measurement density is lower) on the side surface. Thus, the side surface of the building b on the right side is a measurement low-accuracy region when viewed from the position of the vehicle 1. The measurement impossible region and the measurement low-accuracy region will be described later in more detail.

In these diagrams, the interval of positional data acquisition (interval of the positional data acquisition positions Pa) is illustrated in an exaggerated manner. In reality, the interval is several cm and several tens cm as described later. The acquisition positions of positional data in measurement by the actual MMS are not discrete positions as illustrated in, for example, FIGS. 4 to 9 (such as positions on lines arranged at an equal interval and on the circumferences of circles arranged at an equal interval) but continuous positions. Specifically, when illustrated in a horizontal view and a vertical cross-sectional view, the acquisition positions of positional data in measurement by the actual MMS are positions on a curved line such as a sine curve. When illustrated in a bird's eye view, the acquisition positions of positional data in measurement by the actual MMS are positions on a helical line having a central axis at a locus on which the lidar mounted on the vehicle 1 passes.

However, in the following description, it is assumed for simplification of description that the positional data acquisition positions Pa in measurement by the MMS are discrete positions when measurement is performed at an equal interval as illustrated in, for example, FIGS. 4 to 9. The reason why the positional data acquisition positions Pa can be regarded as discrete positions will be briefly described below.

For example, the traveling speed of the vehicle 1 at measurement by the MMS is 50 [km/h] (≈13.9 [m/s]). In addition, the number of pieces of positional data acquired by the lidar in one second is 30,000 [pieces/s]. In addition, the speed of rotation of the lidar is 20 [rotations/s] (in other words, 0.05 [s/rotation]). In this case, the lidar rotates once on a cross-section (x-z plane) each time the vehicle 1 travels by 69.4 [cm] in the traveling direction (y-axis direction) as calculated by Expression (1) below.

69.4 [cm]≈13.9 [m/s]/20 [rotations/s] (1)

In addition, 1,500 pieces of positional data are acquired each time the lidar rotates once as calculated by Expression (2) below. In other words, one piece of positional data is acquired each time the lidar rotates by 0.24°(≈14 minutes 24 seconds).

1,500 [pieces]=30,000 [pieces/s]/20 [rotations/s] (2)

As understood from the above description, positional data acquisition positions existing at every 0.24° on a circumference on the x-z plane exist at an equal interval of 69.4 [cm] in the traveling direction of the vehicle 1 (y-axis direction). Thus, the positional data acquisition positions Pa can be regarded as discrete positions existing at an equal interval in the traveling direction of the vehicle 1 (y-axis direction).

In the above description, it is assumed for simplification that the positional data acquisition positions Pa are positions on the circumference of a circle on a cross-section (x-z plane). However, in reality, the acquisition position of each positional data is a position at which the cross-section (x-z plane) contacts a measurement object. Thus, the distance from the lidar to the acquisition position of positional data is different for each positional data.

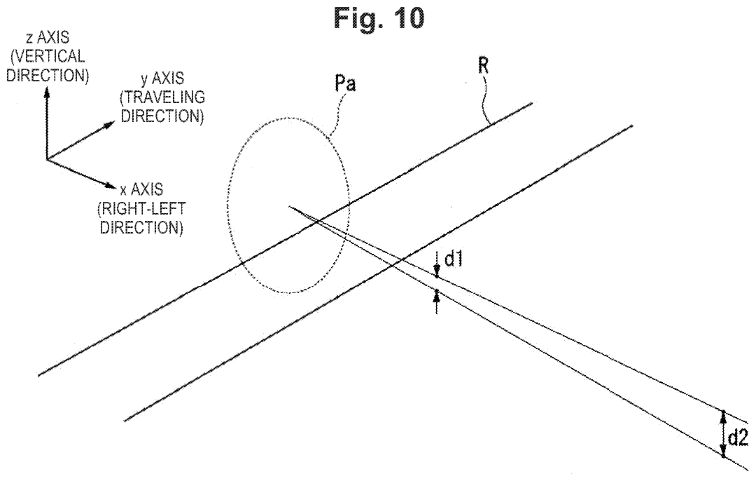

FIG. 10 is a schematic diagram illustrating the relation between the distance from the position of the lidar to the measurement object and the interval of positional data acquisition positions. When the measurement object exists at a position close to the position of the lidar, the interval of two adjacent positional data acquisition positions is d1 as illustrated in, for example, FIG. 10. When the measurement object exists at a position far from the position of the lidar, the interval of two adjacent positional data acquisition positions is d2 as illustrated in, for example, FIG. 10. As illustrated in FIG. 10, the interval of two adjacent positional data acquisition positions is larger as the distance from the position of the lidar to the measurement object is longer (that is, d1<d2).

A specific example will be described below. For example, the distance from the lidar to the measurement object is 5 [m]. In this case, the interval of two adjacent positional data acquisition positions on the circumference of a circle on cross-section (x-z plane) is 1.05 [cm] approximately as indicated in Expression (3) below.

1.05 [cm]≈5 [m]×100×π/1,500 [pieces] (3)

For example, the distance from the lidar to the measurement object is 500 [m]. In this case, the interval of two adjacent positional data acquisition positions on the circumference of a circle on cross-section (x-z plane) is 104.67 [cm] approximately as indicated in Expression (4) below.

104.67 [cm]≈500 [m]×100×π/1,500 [pieces] (4)

As described above, the interval of two adjacent positional data acquisition positions on the circumference of a circle on cross-section (x-z plane) is larger as the distance from the position of the lidar to the position of the measurement object is longer.

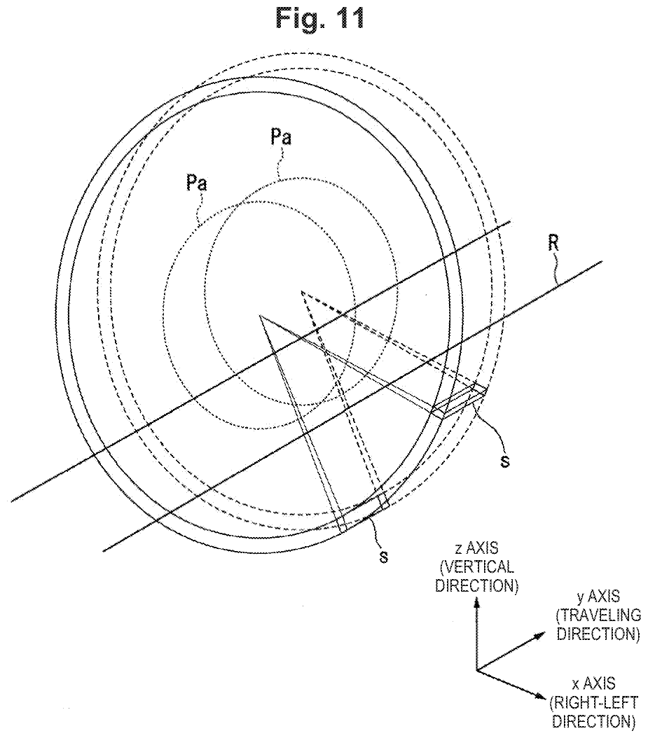

FIG. 11 is a schematic diagram illustrating the size of a space measurable by the conventional MMS. The measurable space size indicates the minimum size of a measurement object, measurement of which is reliably performed by the MMS. In other words, a measurement object smaller than the measurable space size is potentially not hit by a laser beam emitted by the lidar and not measured.

When a measurement object exists at a position close to the lidar, the interval of two adjacent positional data acquisition positions on the circumference of a circle on cross-section (x-z plane) is smaller than the interval of two adjacent cross-sections (x-z planes). Thus, the space measurable by the conventional MMS is a rectangular parallelepiped space s that is longer in the traveling direction of the vehicle 1 as illustrated in FIG. 11.

In reality, a surface of the space s on a cross-section (x-z plane) has a shape similar to a trapezoid in which a side farther from the lidar is slightly longer than a side closer to the lidar.

The length of a side of the space s in a depth direction when viewed from the position of the lidar is determined in accordance with the resolution of the lidar.

As illustrated in FIG. 11, when the distance from the position of the lidar to the position of the measurement object is same, the size of the space s is same irrespective of the height of a position at which the measurement object exists.

In this manner, the interval of positional data acquisition positions is longer in the traveling direction (y-axis direction) than in the circumferential direction when the distance from the position of the lidar to the position of the measurement object is short. FIG. 11 illustrates, with two ellipses, the acquisition positions Pa of positional data acquired by the MMS while the vehicle 1 travels along the road R in the upper-right direction from a lower-left part. Two rectangular parallelepipeds (spaces s) illustrated in FIG. 11 are measurable spaces for which the distance from the position of the lidar to the position of the measurement object is same and the directions (laser beam emission directions) of which are different from each other on the cross-section (x-z plane).

In this manner, when the distance from the position of the lidar to the position of the measurement object is short, each space s has a small rectangular parallelepiped shape that is long in the traveling direction of the vehicle 1 (y-axis direction) and relatively short in a direction on the cross-section (x-z plane).

The length of each side of the rectangular parallelepiped space s corresponds to the interval of adjacent positional data acquisition positions in up-down and front-back directions (in other words, the y-axis and z-axis directions). When the distance from the position of the lidar to the position of the measurement object is short, the length of a side in the direction of laser beam emission by the lidar (for example, the x-axis direction when the measurement object exists at a height same as that of the lidar) and the length of a side in the circumferential direction (for example, the z-axis direction when the measurement object exists at a height same as that of the lidar) of a circle on the cross-section (x-z plane) are shorter than the length of a side in the traveling direction of the vehicle 1 (y-axis direction). When the distance from the position of the lidar to the position of the measurement object is long, the length of a side in the direction of laser beam emission by the lidar and the length of a side in the circumferential direction of a circle on the cross-section (x-z plane) are longer than the length of a side in the traveling direction of the vehicle 1 (y-axis direction).

In the above-described specific example, the length of a side of the space s in the traveling direction of the vehicle 1 (y-axis direction) is 69.4 [cm]. The length of a side of the space s in the circumferential direction of a circle on the cross-section (x-z plane) (for example, the z-axis direction when the measurement object exists at a height same as that of the lidar) is 1.05 [cm]. When the resolution of the lidar is, for example, 5 [cm], the length of a side of the space s in the direction of laser beam emission by the lidar (for example, the x-axis direction when the measurement object exists at a height same as that of the lidar) is 5 [cm]. Thus, the space s has a rectangular parallelepiped shape of 69.4 [cm]×1.05 [cm]×5 [cm].

Although not illustrated, the space s when the distance from the lidar to the measurement object is long has a rectangular parallelepiped shape that is relatively short in the traveling direction of the vehicle 1. In the above-described specific example, the length of a side of the space s in the traveling direction of the vehicle 1 (y-axis direction) is 69.4 [cm]. The length of a side of the space s in the circumferential direction of a circle on the cross-section (x-z plane) (for example, the z-axis direction when the measurement object exists at a height same as that of the lidar) is 104.67 [cm]. When the resolution of the lidar is, for example, 100 [cm], the length of a side of the space s in the direction of laser beam emission by the lidar (for example, the x-axis direction when the measurement object exists at a height same as that of the lidar) is 100 [cm]. Thus, the space s has a rectangular parallelepiped shape of 69.4 [cm]×104.67 [cm]×100 [cm].

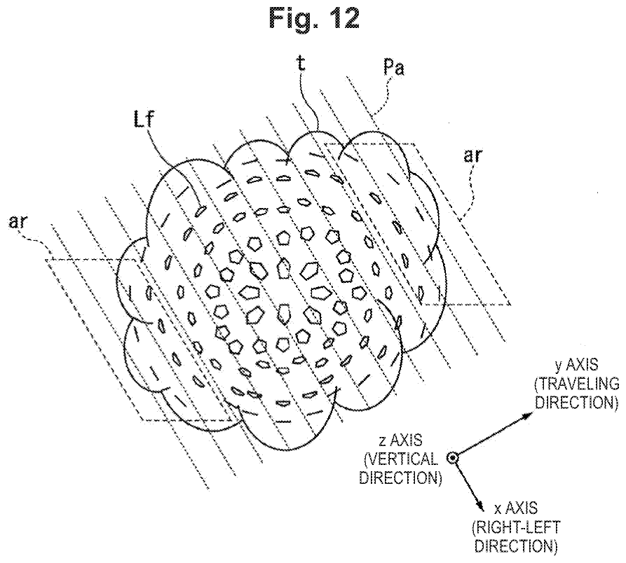

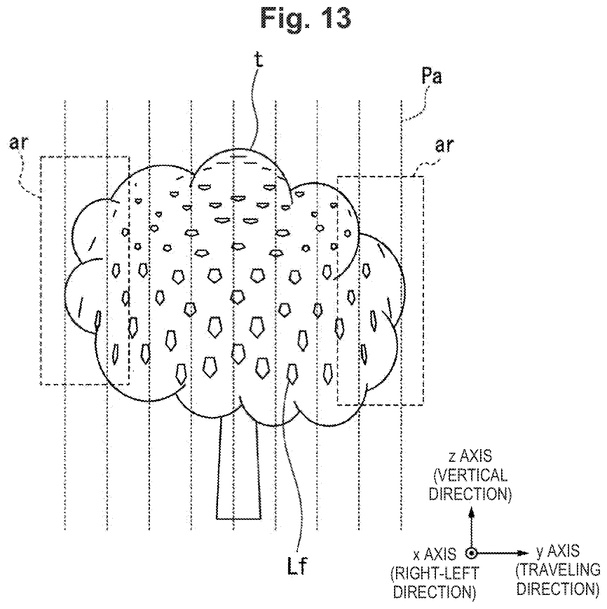

FIGS. 12 and 13 are each a schematic diagram illustrating a measurement insensible region when the measurement object is a tree. FIGS. 12 and 13 illustrate a horizontal view and a vertical cross-sectional view, respectively, of a tree t and its surroundings, the tree t existing in a space traveled by the vehicle 1 on which the MMS configured to measure surroundings of the road R is mounted.

As illustrated in FIGS. 12 and 13, the tree t has a large number of leaves Lf as positional data acquisition targets. FIGS. 12 and 13 each illustrate positional data acquisition positions Pa. As illustrated in FIGS. 12 and 13, measurement insensible regions ar are generated on the front and back sides of the tree t in the traveling direction of the vehicle 1 (y-axis direction). Each measurement insensible region ar is a region in which measurement by the MMS is difficult.

The measurement insensible regions ar are generated because the front surface of each leaf Lf typically points radially from the trunk of the tree t in a direction outward from the tree t to acquire the sun light as illustrated in FIG. 12. Accordingly, in the tree t, side surfaces of leaves Lf growing at positions on a side in the traveling direction of the vehicle 1 (y-axis direction) and on a side in a direction opposite thereto face the vehicle 1 passing nearby. The length of the side surface of each leaf Lf (in other words, the thickness of the leaf Lf) is typically short (for example, shorter than 1 [mm]). In addition, the MMS typically has difficulties in acquiring positional data at an interval smaller than the thickness of the leaf Lf.

When the measurement insensible regions ar are generated, the shape of the tree t, which is obtained from positional data acquired by the MMS is narrower in the traveling direction of the vehicle 1 (y-axis direction) than the actual shape of the tree t. In this manner, when the measurement insensible regions ar are generated, false recognition that the MMS recognizes the size of the measurement object to be smaller than its actual size potentially occurs.

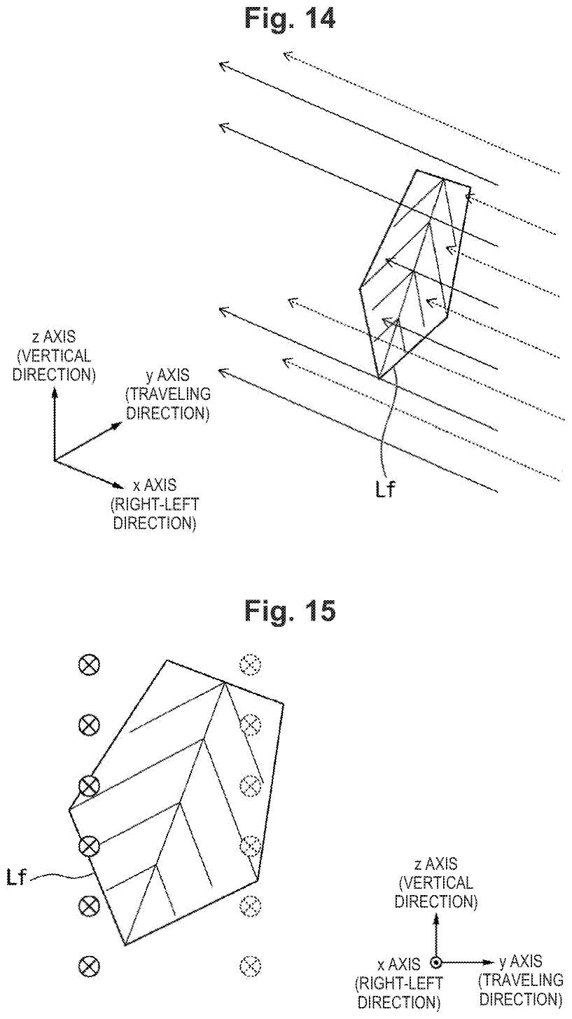

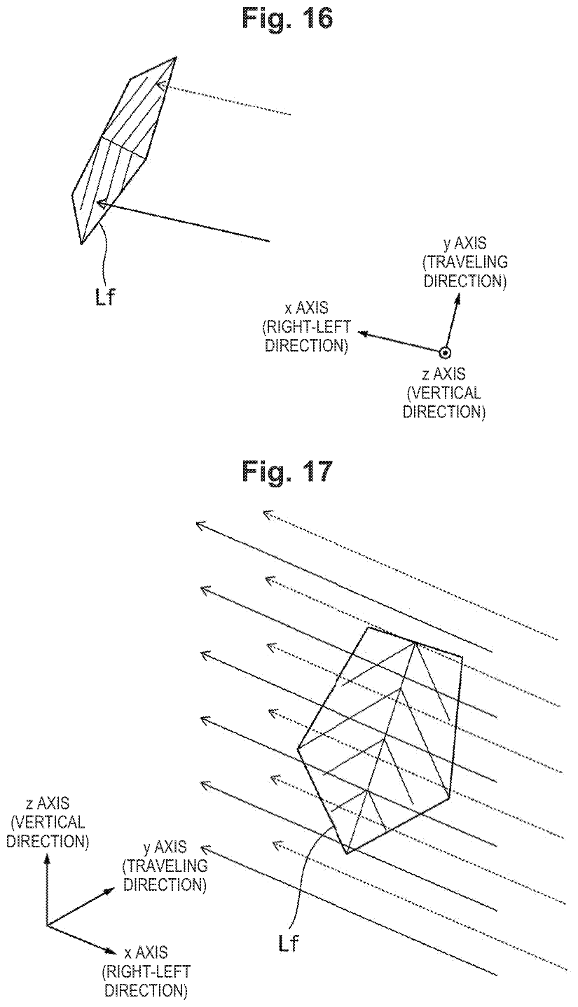

FIGS. 14 to 19 are each a schematic diagram illustrating the relation between the orientation of the leaf Lf and the direction of laser beam emission by the lidar. In FIGS. 14, 16, 17, and 19, each solid line arrow and each dotted line arrow represent laser beam emission. Distinction between the solid line arrow and the dotted line arrow is based on difference in the acquisition timing of positional data. Specifically, the solid line arrow represents each laser beam emission to a positional data acquisition position Pa at an acquisition timing. The dotted line arrow represents each laser beam emission to a positional data acquisition position Pa at an acquisition timing different from the above-described acquisition timing.

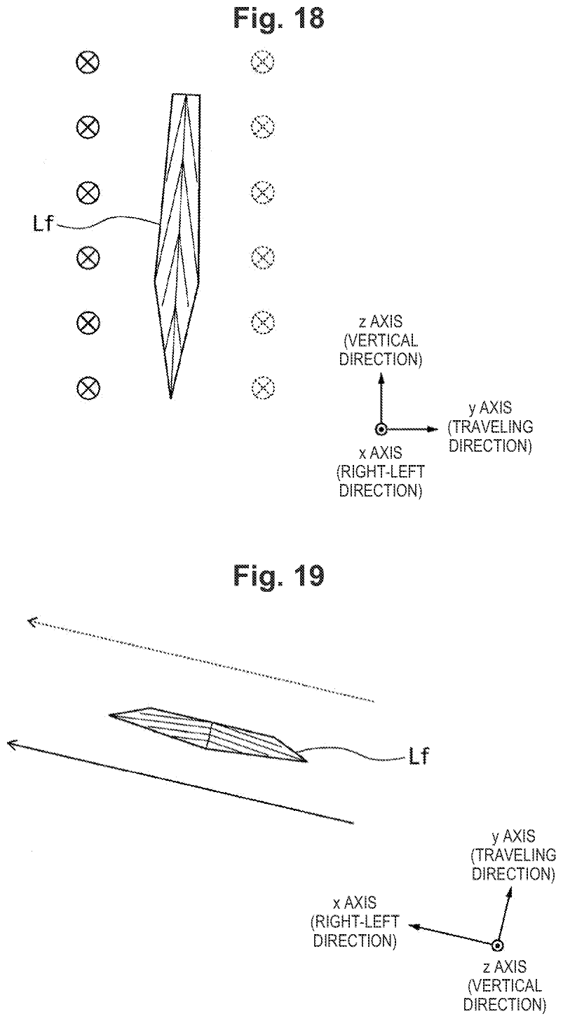

In FIGS. 15 and 18, each mark with “X” illustrated in a circle corresponds to an arrow in FIGS. 14, 16, 17, and 19. The mark indicates laser beam emission into the drawing. Distinction between a mark illustrated with a solid line and a mark illustrated with a dotted line is based on difference in the acquisition timing of positional data. Specifically, the solid line mark represents each laser beam emission to a positional data acquisition position Pa at an acquisition timing. The dotted line mark represents each laser beam emission to a positional data acquisition position Pa at an acquisition timing different from the above-described acquisition timing.

FIGS. 14 to 16 illustrate a bird's eye view, a vertical cross-sectional view, and a horizontal view, respectively, of a leaf Lf and its surroundings, the leaf Lf growing at a position not in a measurement insensible region ar in the tree t existing in a space traveled by the vehicle 1 on which the MMS configured to measure surroundings of the road R is mounted.

As illustrated in FIGS. 14 to 16, the front surface of the leaf Lf growing at a position not in a measurement insensible region ar faces in a direction nearly parallel to the y-z plane. In other words, the front surface of the leaf Lf faces in a direction nearly orthogonal to the direction of laser beam emission by the lidar (the x-axis direction). Accordingly, the leaf Lf growing at a position not in a measurement insensible region ar is likely to be irradiated with a laser beam emitted by the lidar.

FIGS. 17 to 19 illustrate a bird's eye view, a vertical cross-sectional view, and a horizontal view, respectively, of a leaf Lf and its surroundings, the leaf Lf growing in a measurement insensible region ar in the tree t existing in a space traveled by the vehicle 1 on which the MMS configured to measure surroundings of the road R is mounted.

As illustrated in FIGS. 17 to 19, the front surface of the leaf Lf growing in a measurement insensible region ar faces in a direction nearly parallel to the cross-section (x-z plane). In other words, the front surface of the leaf Lf faces in a direction nearly parallel to the direction of laser beam emission by the lidar (the x-axis direction). Accordingly, the leaf Lf growing in a measurement insensible region ar is unlikely to be irradiated with a laser beam emitted by the lidar.

The interval of laser beam emission by the lidar is short in the z-axis direction, and the longitudinal direction of the leaf Lf is substantially in the z-axis direction as illustrated in FIG. 18. Thus, even when slightly tilted, the leaf Lf is unlikely to be irradiated with a laser beam emitted by the lidar.

In this manner, measurement insensible regions ar are generated at parts of the tree t on the front and back sides in the y-axis direction (in other words, parts of the tree t on the side in the traveling direction of the vehicle 1 and on the side in the direction opposite thereto) depending on the relation between the orientation of the leaf Lf and the direction of laser beam emission by the lidar. The measurement insensible regions ar are generated because no component in the y-axis direction (traveling direction of the vehicle 1) is included in the direction of laser beam emission by the lidar.

Specifically, the front surfaces of the leaves Lf growing in parts of the tree t on the front and back sides in the y-axis direction (in other words, parts of the tree t on the side in the traveling direction of the vehicle 1 and on the side in the direction opposite thereto) face in the traveling direction of the vehicle 1 or the direction opposite thereto in many cases. Thus, side surfaces of the leaves Lf growing in parts of the tree t on the front and back sides in the y-axis direction face the vehicle 1. A laser beam is emitted in the direction orthogonal to the traveling direction of the vehicle 1 (in other words, a direction in which no component in the y-axis direction is included). Accordingly, the front surface of each leaf Lf and the emission direction of the laser beam are positioned in parallel to each other, and thus the measurement insensible regions ar are generated.

Since the measurement insensible regions ar are generated at parts on the front and back sides in the y-axis direction, false recognition that the MMS recognizes the width of the tree t to be smaller than the actual width potentially occurs.

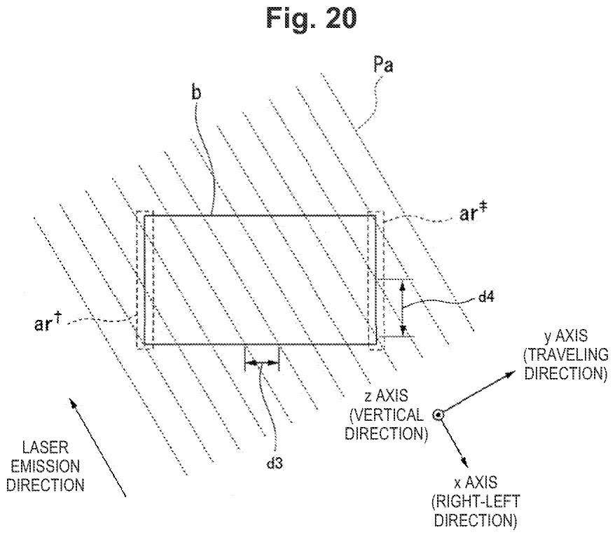

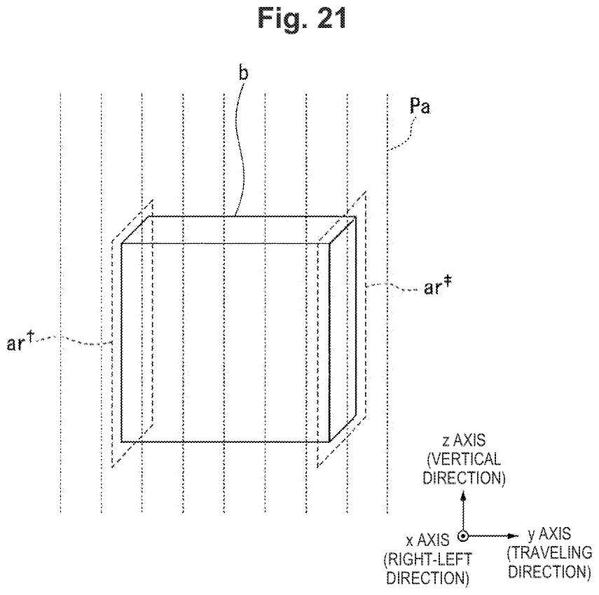

FIGS. 20 and 21 are each a schematic diagram illustrating the measurement impossible region and the measurement low-accuracy region when the measurement object is a building. FIGS. 20 and 21 illustrate a horizontal view and a vertical cross-sectional view, respectively, of a building b and its surroundings, the building b existing in a space traveled by the vehicle 1 on which the MMS configured to measure surroundings of the road R is mounted.

As illustrated in FIG. 20, the emission direction of a laser beam emitted by the lidar is in the negative direction along the x axis. Thus, a side surface of the building b on the left side in FIGS. 20 and 21 is a blind spot when viewed from the position of the vehicle 1 passing by the building b. Accordingly, a measurement impossible region

ar^{†}
is generated on the side surface of the building b on the left side.

A side surface of the building b on the right side in FIGS. 20 and 21 is more nearly parallel to the emission direction of a laser beam than a side surface of the building b on the vehicle 1 side (the front side thereof when viewed from the position of the vehicle 1). Accordingly, an interval d4 of positional data acquisition positions Pa on the side surface of the building b on the right side is larger than an interval d3 of positional data acquisition positions Pa on the side surface of the building b on the vehicle 1 side (the front side thereof when viewed from the position of the vehicle 1) (d4>d3). In other words, the measurement density is lower on the side surface of the building b on the right side. Accordingly, a measurement low-accuracy region

a r^{‡}
is generated on the side surface of the building b on the right side.

### First Embodiment

A first embodiment of the present invention will be described below with reference to the accompanying drawings.

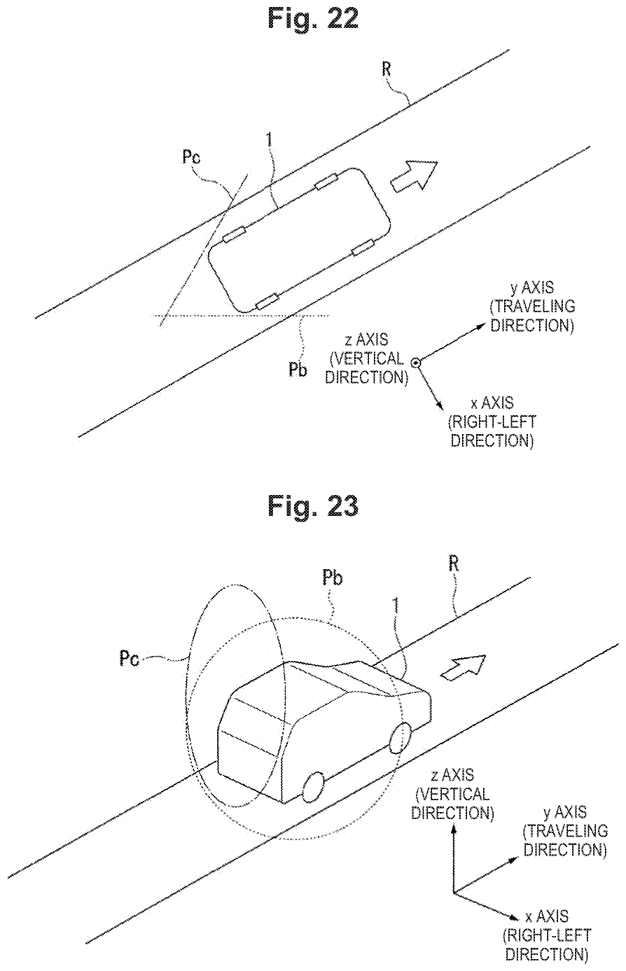

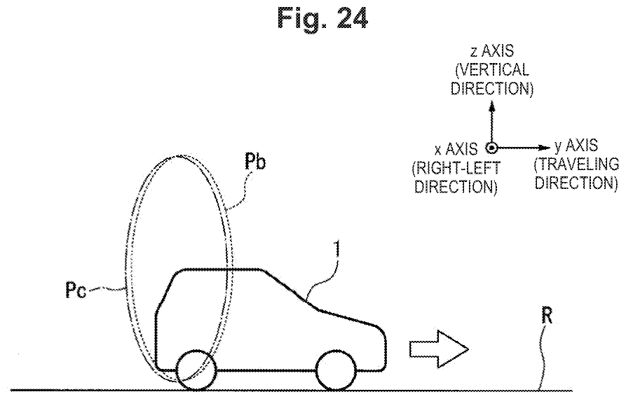

FIGS. 22 to 24 are each a schematic diagram illustrating the position of positional data acquisition by an MMS according to the first embodiment of the present invention. In the present embodiment, the vehicle 1 on which the MMS is mounted travels on the road R. FIGS. 22 to 24 illustrate a horizontal view, a bird's eye view, and a vertical cross-sectional view, respectively, of a space in which the vehicle 1 exists at a time point while the vehicle 1 is traveling.

A lidar (not illustrated) is mounted at the back part of the vehicle 1. The MMS measures, through the lidar, surroundings of the road R on which the vehicle 1 travels, and acquires the positional data of an object that exists in surroundings of the road R.

Difference of the vehicle 1 according to the present embodiment from the above-described conventional technology is that surfaces constituted by positional data acquisition positions are two surfaces tilted relative to a cross-section (surface orthogonal to the traveling direction of the vehicle 1) in the right-left direction of the vehicle 1 (x-axis direction) as understood with reference to FIG. 22, in particular. Hereinafter, each tilted surface is referred to as a “measurement surface”. The MMS acquires positional data by performing measurement in each direction on the measurement surface.

In FIGS. 22 to 24, a dotted line represents positional data acquisition positions Pb as a set of positional data acquisition positions on a measurement surface facing the right back side with respect to the traveling direction of the vehicle 1 (y-axis direction). In addition, in FIGS. 22 to 24, a dashed and single-dotted line represents positional data acquisition positions Pc as a set of positional data acquisition positions on a measurement surface facing the left back side with respect to the traveling direction of the vehicle 1 (y-axis direction).

In the present embodiment, the vehicle 1 includes a lidar configured to perform measurement for the positional data acquisition positions Pb, and a lidar configured to perform measurement for the positional data acquisition positions Pc. The two lidars are installed at respective corners on the back side on the roof of the vehicle 1. However, the vehicle 1 is not limited to such a configuration but may include one lidar capable of performing measurement for both the positional data acquisition positions Pb and Pc.

The following describes four main reasons why two lidars configured to emit laser beams in direction different from each other are desirably installed at both corners on the back side on the roof of the vehicle 1 as described above.

When measurement targets are positional data acquisition positions on a plurality of measurement surfaces, device cost can be reduced most with two lidars as a minimum configuration. The first reason why the number of installed lidars is two is because device cost can be reduced most with this configuration.

To have a wider measurement range, a wider visual field is desirably obtained in a view of surroundings from the position of each lidar installed on the vehicle 1. When the installation positions of the lidars are at both corners on the roof of the vehicle 1, a smaller range of the visual field is blocked by the main body of the vehicle 1. The second reason why the installation positions of the lidars are at both corners on the roof of the vehicle 1 is because a wider visual field is obtained with this configuration.

Typically, an engine room of the vehicle 1 is installed at a front part of the vehicle 1 (position on the front side of the position of the driver seat). With such a shape of the vehicle 1 taken into consideration, it is thought that a smaller range of the visual field is blocked when each lidar is installed at a position on the back side where no engine room is provided than when each lidar is installed at a position on the front side of the vehicle 1 at which the visual field is blocked by the engine room. The third reason why each lidar is installed at a position on the back side on the roof of the vehicle 1 is because the visual field of a wider range is obtained.

To reduce a region as a blind spot in the measurement object, it is desirable that a plurality of measurement surfaces are not parallel to each other but intersect with each other at a larger angle with respect to the position of the vehicle 1. When the two lidars are positioned at the right and left corners on the back side on the roof of the vehicle 1, a range of the visual field, which is blocked by the main body of the vehicle 1 is reduced and two measurement surfaces intersect with each other at a larger angle. The fourth reason why the installation position of the lidar are positioned at the right and left corners on the back side on the roof of the vehicle 1 is because the visual field of a wider range is obtained and a region as a blind spot in the measurement object is reduced.

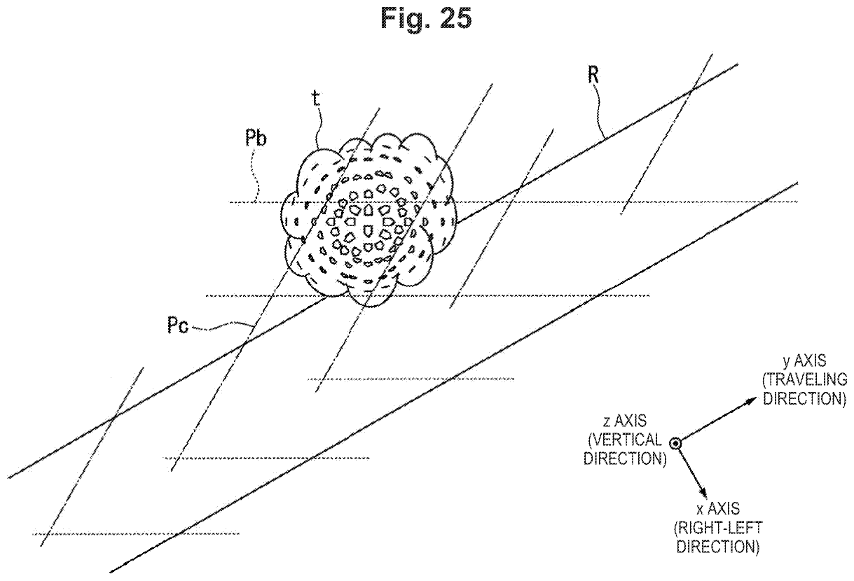

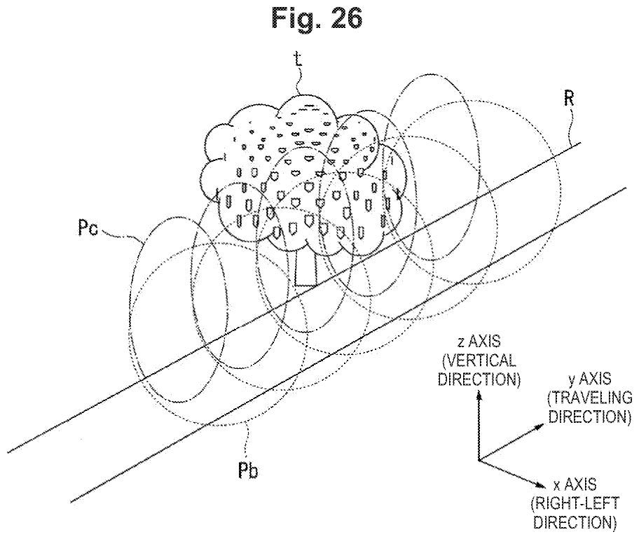

FIGS. 25 to 27 are each a schematic diagram illustrating exemplary measurement by the MMS according to the first embodiment of the present invention. FIGS. 25 to 27 illustrate a horizontal view, a bird's eye view, and a vertical cross-sectional view, respectively, of a space traveled by the vehicle 1 on which the MMS configured to measure surroundings of the road R is mounted.

The vehicle 1 travels on the road R at a constant speed. Accordingly, the MMS mounted on the vehicle 1 can acquire the positional data of an object that exists in surroundings of the road R at constant intervals. For example, as illustrated in FIGS. 25 to 27, one tree t exists on the left side of the road R with respect to the traveling direction of the vehicle 1. The MMS acquires the positional data of the tree t when passing by the tree t.

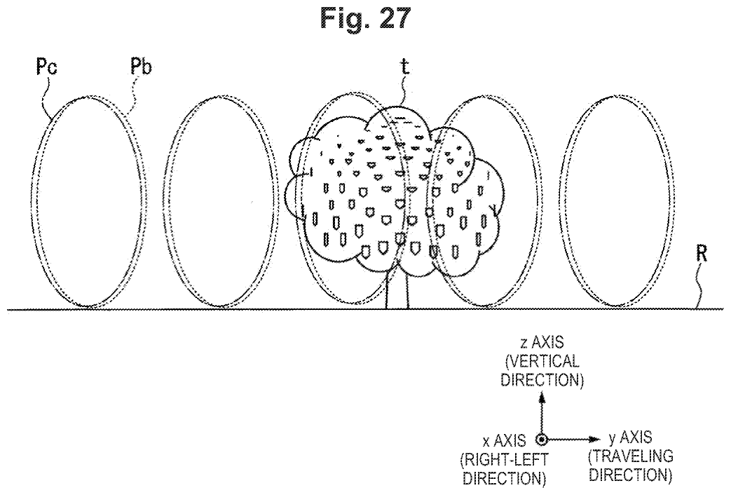

FIGS. 25 to 27 each illustrate all positional data acquisition positions Pb and all positional data acquisition positions Pc when the vehicle 1 travels on the road R. As understood from the horizontal view of FIG. 25 and the vertical cross-sectional view of FIG. 27, two measurement surfaces constituted by the positional data acquisition positions Pb as measurement targets of a lidar (hereinafter referred to as a “right lidar”) installed on the right back side of the vehicle 1 and two measurement surfaces constituted by the positional data acquisition positions Pc as measurement targets of a lidar (hereinafter referred to as a “left lidar”) installed on the left back side of the vehicle 1 overlap the tree t.

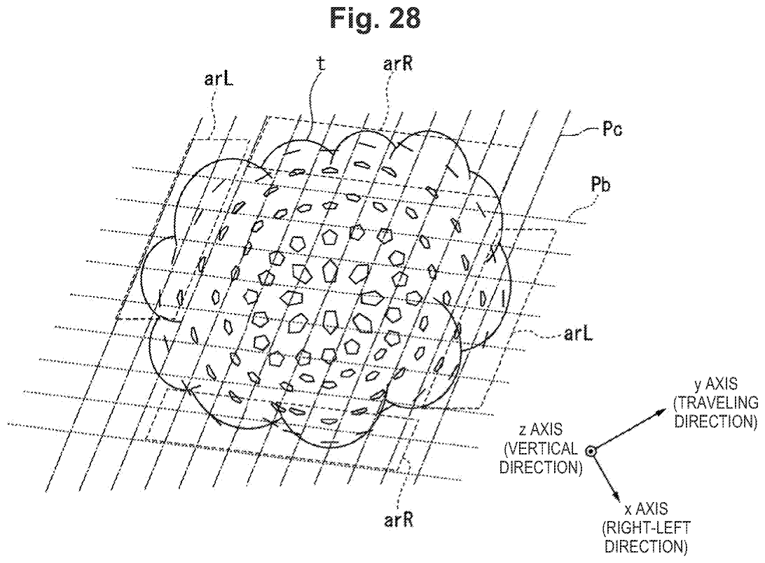

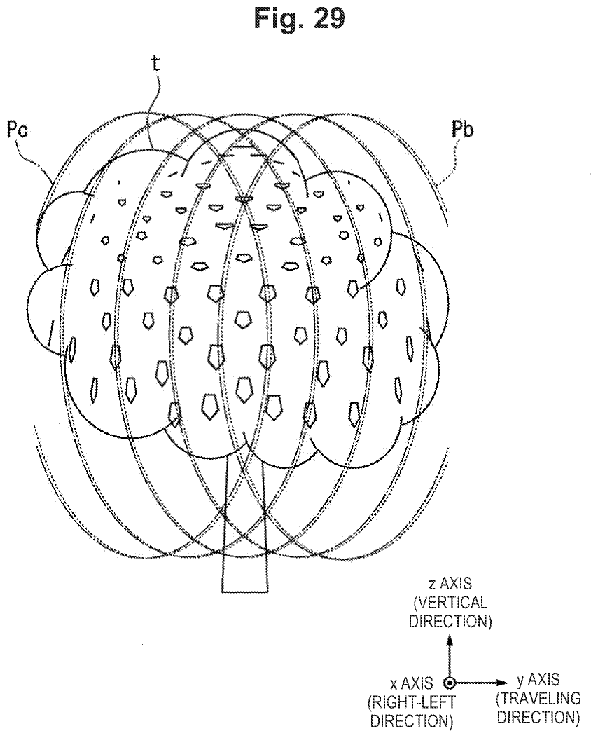

FIGS. 28 and 29 are each a schematic diagram for description of measurement insensible regions when the measurement object is a tree. FIGS. 28 and 29 illustrate a horizontal view and a vertical cross-sectional view, respectively, of a tree t and its surroundings, the tree t existing in a space traveled by the vehicle 1 on which the MMS configured to measure surroundings of the road R is mounted.

As illustrated in FIGS. 28 and 29, the tree t has a large number of leaves Lf as positional data acquisition targets. FIGS. 28 and 29 each illustrate the positional data acquisition positions Pb of the right lidar and the positional data acquisition positions Pc of the left lidar. As illustrated in FIG. 28, two measurement insensible regions arR and two measurement insensible regions arL are generated on four sides of the tree t.

As described above, a measurement insensible region is a region in which measurement by the MMS is difficult. A measurement insensible region arR is a region in which measurement by the right lidar is difficult. As illustrated, each measurement insensible region arR is generated in a direction parallel to the measurement surface made of the positional data acquisition positions Pb. A measurement insensible region arL is a region in which measurement by the left lidar is difficult. As illustrated, each measurement insensible region arL is generated in an orientation parallel to the measurement surface made of the positional data acquisition positions Pc. Illustrations of the measurement insensible regions are omitted in FIG. 29 to avoid complication of the drawing.

As illustrated in FIG. 28, no overlapping region in which the four measurement insensible regions overlap each other is generated. Thus, a measurement insensible region arR in which measurement by the right lidar is difficult is measurable by the left lidar. In addition, a measurement insensible region arL in which measurement by the left lidar is difficult is measurable by the right lidar.

In this manner, according to the present embodiment, measurement by the right lidar and measurement by the left lidar complement each other, and thus there is no region in which positional data acquisition by any lidar is difficult. Accordingly, the probability of occurrence of false recognition that the MMS recognizes the width of the tree t to be smaller than the actual width due to generation of a measurement insensible region is significantly decreased as compared to conventional cases (or eliminated).

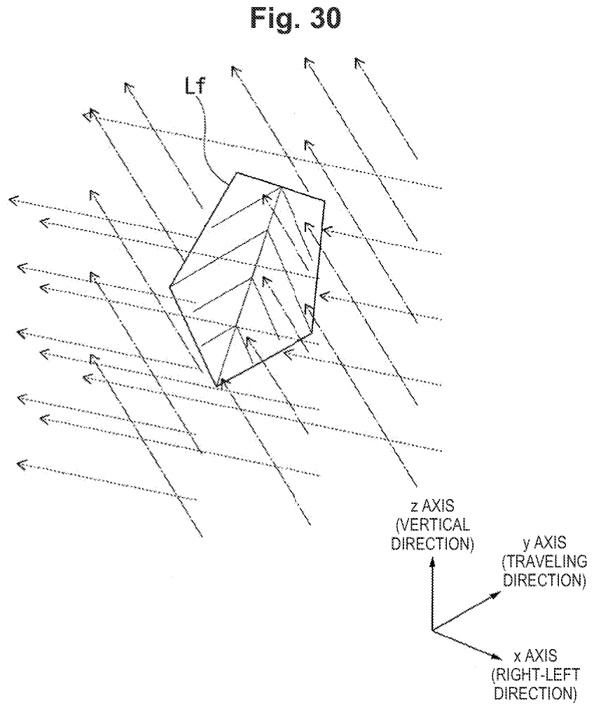

FIGS. 30 to 32 are each a schematic diagram illustrating the relation between the orientation of the leaf Lf and the direction of laser beam emission by the lidar. In FIGS. 30 to 32, each dotted line arrow and each dashed and single-dotted line arrow represent laser beam emission. Distinction between a solid line arrow and the dotted line arrow is based on difference of a lidar having emitted a laser beam. Specifically, the dotted line arrow represents each laser beam emission from the right lidar to a positional data acquisition positions Pb. The dashed and single-dotted line arrow represents each laser beam emission from the left lidar to a positional data acquisition positions Pc.

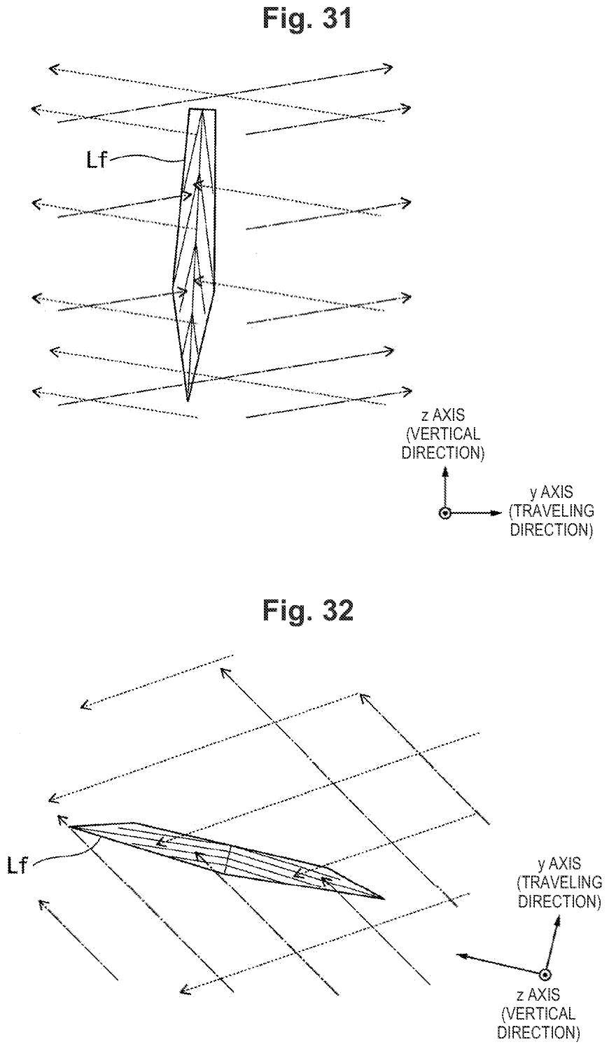

The orientation of the leaf Lf illustrated in FIGS. 30 to 32 is same as that in FIGS. 17 to 19, respectively, referred to in the description of the conventional technology. In particular, comparison between FIGS. 18 and 31 and comparison between FIGS. 19 and 32 indicate that the leaf Lf is irradiated with no laser beams in the conventional technology, but in the present embodiment, the leaf Lf is irradiated with laser beams emitted along two measurement surfaces at angles different from each other. In this manner, according to the present embodiment, a laser beam emitted by a lidar is incident on the leaf Lf in an orientation with which the laser beam is unlikely to be incident in conventional cases. Accordingly, it is possible to acquire the positional data of the leaf Lf, which cannot be acquired in conventional cases.

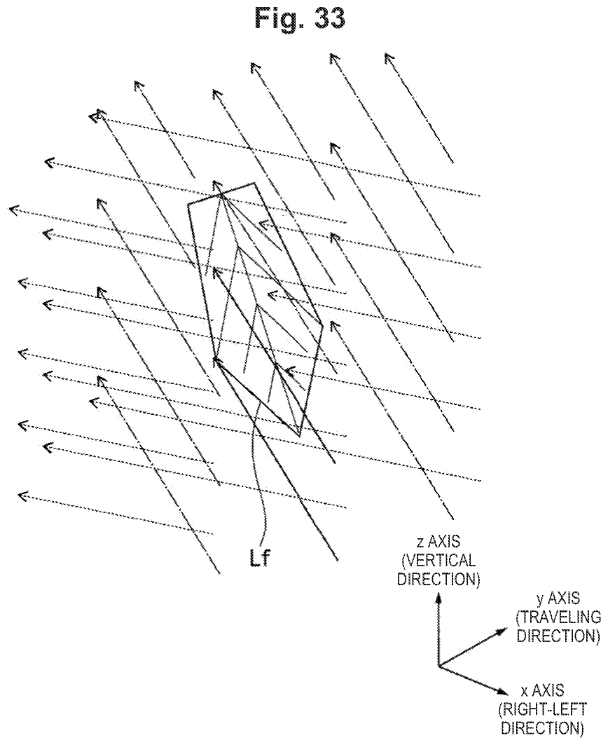

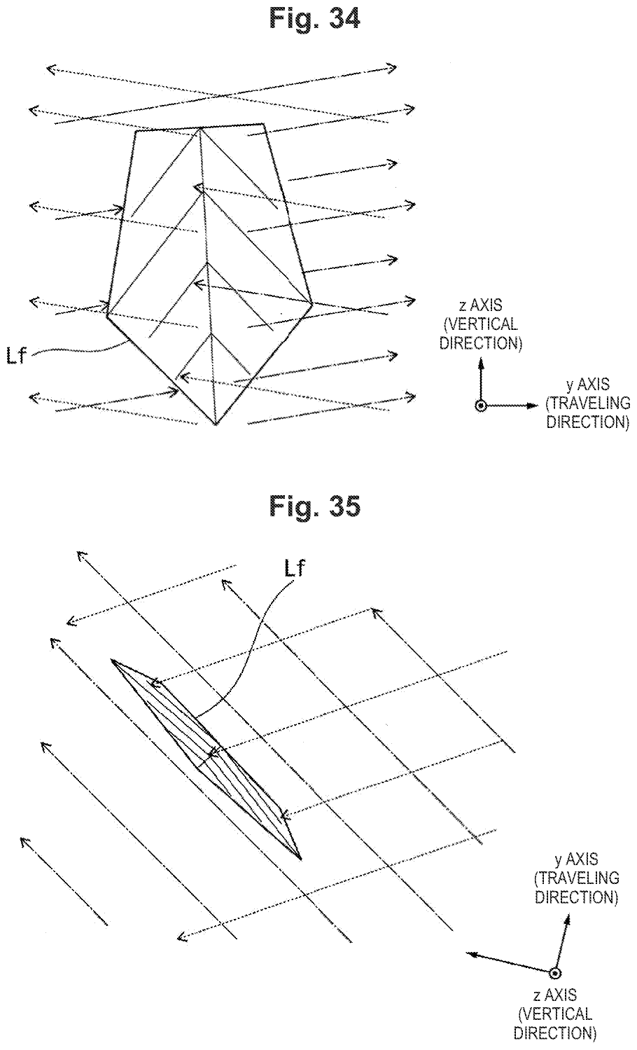

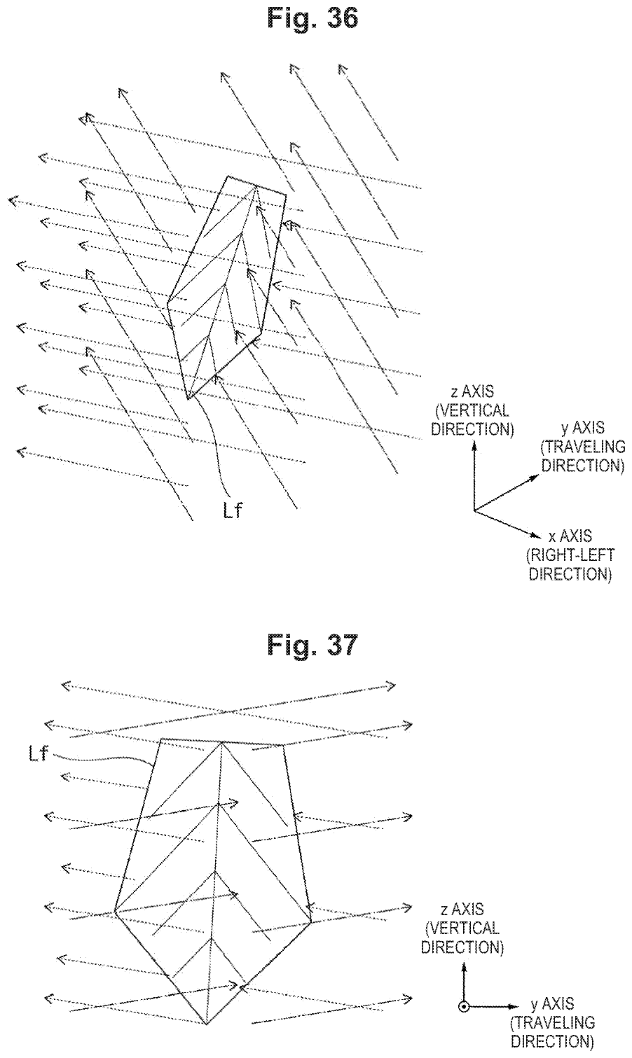

The state of laser beam emission in a measurement insensible region will be described below. FIGS. 33 to 35 illustrate a bird's eye view, a vertical cross-sectional view, and a horizontal view, respectively, of a leaf Lf and its surroundings, the leaf Lf growing in a measurement insensible region arL in the tree t. FIGS. 36 to 38 illustrate a bird's eye view, a vertical cross-sectional view, and a horizontal view, respectively, of a leaf Lf and its surroundings, the leaf Lf growing in a measurement insensible region arR in the tree t.

In FIGS. 33 to 38, each dotted line arrow and each dashed and single-dotted line arrow represent laser beam emission. Distinction between a solid line arrow and the dotted line arrow is based on difference of a lidar having emitted a laser beam. Specifically, the dotted line arrow represents each laser beam emission from the right lidar to a positional data acquisition position Pb. The dashed and single-dotted line arrow represents each laser beam emission from the left lidar to a positional data acquisition position Pc.

As understood with reference to FIG. 35, in particular, the leaf Lf growing in the measurement insensible region arL is irradiated with no laser beams emitted by the left lidar. However, the leaf Lf is irradiated with laser beams emitted by the right lidar at three places.

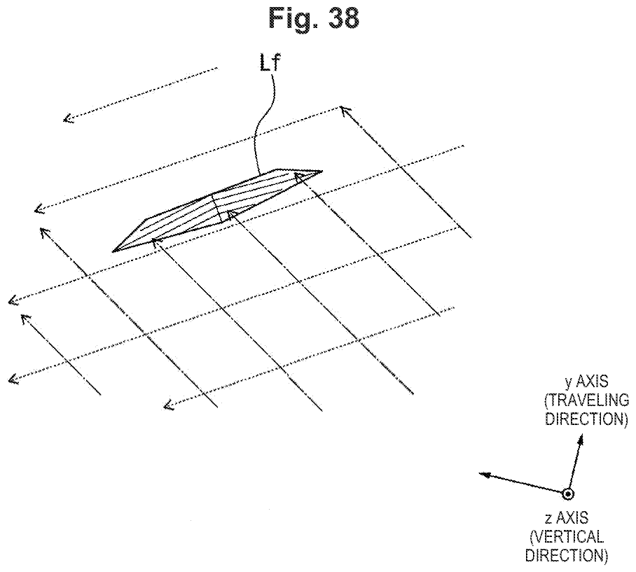

As understood with reference to FIG. 38, in particular, the leaf Lf growing in the measurement insensible region arR is irradiated with no laser beams emitted by the right lidar. However, the leaf Lf is irradiated with laser beams emitted by the left lidar at three places.

In this manner, according to the present embodiment, a leaf Lf is irradiated with at least one of a laser beam emitted by the right lidar and a laser beam emitted by the left lidar when the orientation of the leaf Lf is any orientation such as the orientation illustrated in FIGS. 30 to 32, the orientation illustrated in FIGS. 33 to 35, or the orientation illustrated in FIGS. 36 to 38. Thus, according to the present embodiment, it is possible to significantly reduce a measurement insensible region (or eliminate occurrence thereof).

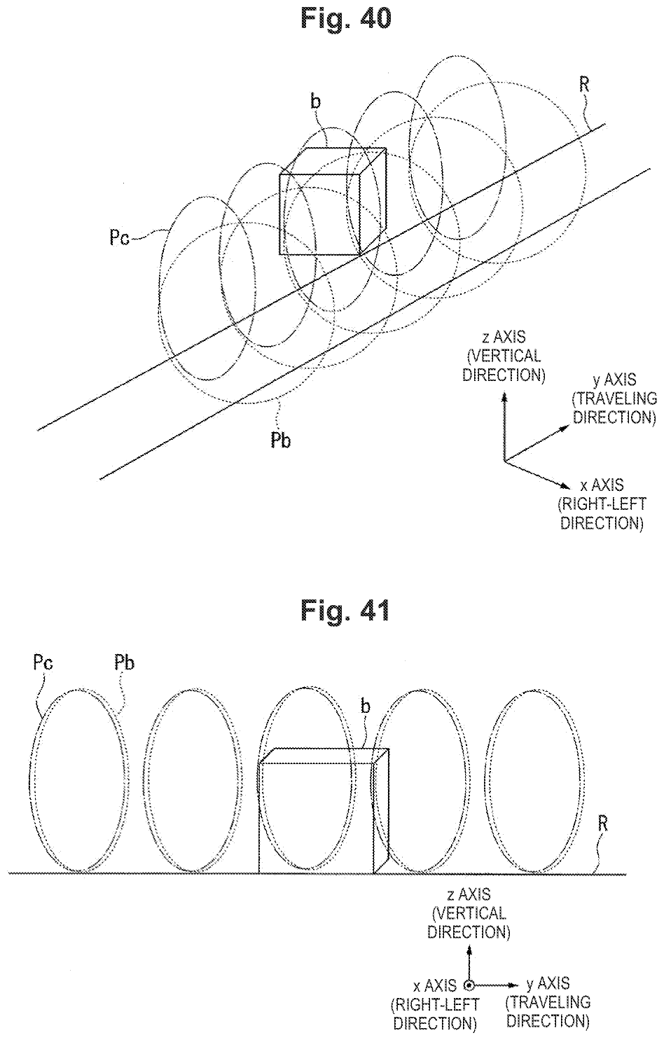

Similarly to FIGS. 25 to 27, FIGS. 39 to 41 are each a schematic diagram illustrating exemplary measurement by the MMS according to the first embodiment of the present invention. FIGS. 25 to 27 illustrate a horizontal view, a bird's eye view, and a vertical cross-sectional view, respectively, of a space traveled by the vehicle 1 on which the MMS configured to measure surroundings of the road R is mounted.

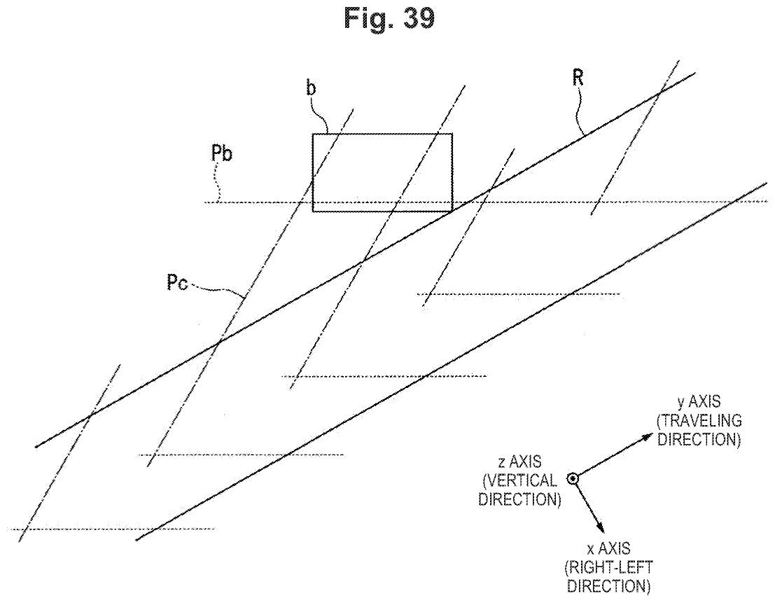

The vehicle 1 travels on the road R at a constant speed. Accordingly, the MMS mounted on the vehicle 1 can acquire the positional data of an object that exists in surroundings of the road R at constant intervals. For example, as illustrated in FIGS. 39 to 41, one building b exists on the left side of the road R with respect to the traveling direction of the vehicle 1. The MMS acquires the positional data of the building b when passing by the building b.

As understood with reference to FIG. 39, in particular, according to the present embodiment, a measurement surface constituted by positional data acquisition positions Pb and a measurement surface constituted by positional data acquisition positions Pc are two surfaces tilted relative to a cross-section (surface orthogonal to the traveling direction of the vehicle 1) in the right-left direction of the vehicle 1 (x-axis direction). With this configuration, a laser beam is incident on the side surface (above-described measurement impossible region) of the building b on the left side, which is a blind spot in conventional cases when viewed from the position of the vehicle 1 passing by the building b. Accordingly, the measurement impossible region is reduced as compared to conventional cases.

Moreover, a laser beam is incident at a more nearly orthogonal angle (in other words, at a higher measurement density) on the side surface (above-described measurement low-accuracy region) of the building b on the right side, at which the measurement density is low in conventional cases because the side surface is positioned substantially in parallel to the right-left direction of the vehicle 1 (x-axis direction). Accordingly, the measurement low-accuracy region is reduced as compared to conventional cases.

According to the present embodiment, when the shape of the building b on a horizontal plane (x-y plane) is a rectangle, it is possible to eliminate the measurement impossible region depending on the angle of installation of the building b on the road R. For example, when the angle of each side surface of the building b with respect to the traveling direction of the vehicle 1 is an angle close to 45° and the angle between two measurement surfaces is an angle (acute angle) smaller than 45°, a laser beam to at least one of the two measurement surfaces is incident on each of the four side surfaces of the building b.

According to the present embodiment, for example, when the shape of the building b on a horizontal plane (x-y plane) is a rhombus, a parallelogram, or the like and the longitudinal direction of the shape is close to the right-left direction of the vehicle 1 (x-axis direction), the probability that the measurement impossible region can be eliminated further increases.

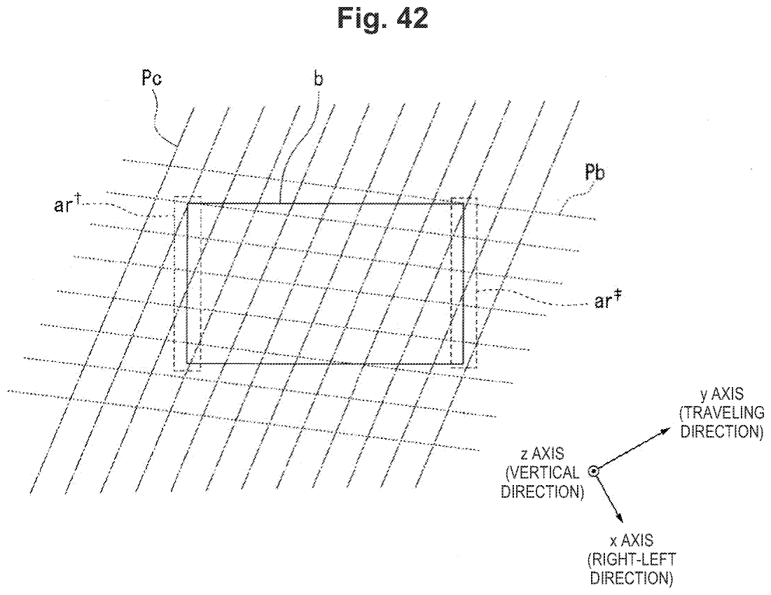

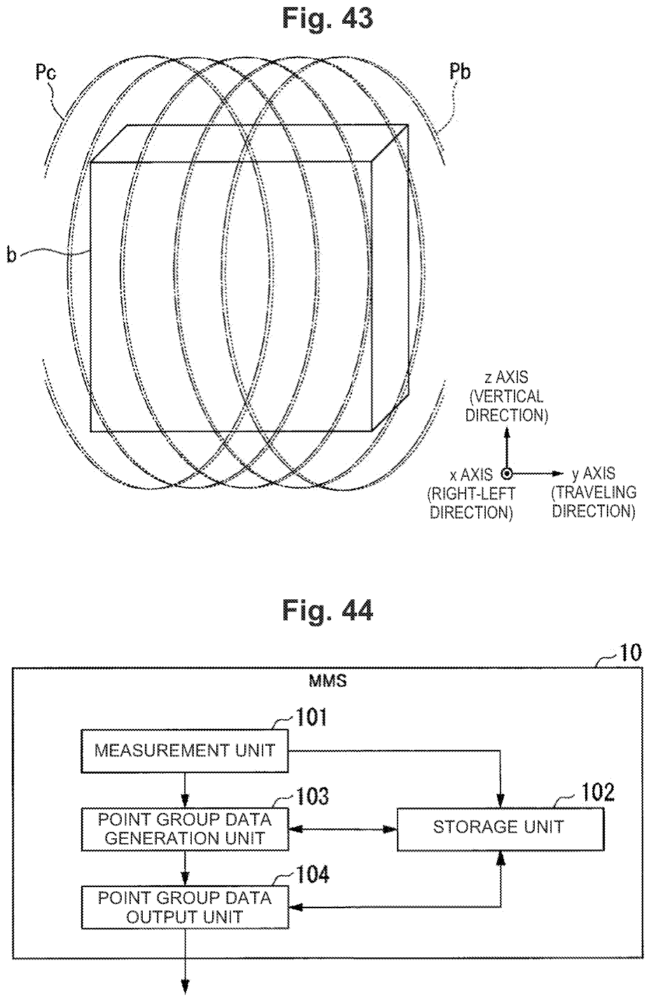

FIGS. 42 to 43 are each a schematic diagram for description of the measurement impossible region and the measurement low-accuracy region when the measurement object is a building. FIGS. 42 to 43 illustrate a horizontal view and a vertical cross-sectional view, respectively, of a building b and its surroundings, the building b existing in a space traveled by the vehicle 1 on which the MMS configured to measure surroundings of the road R is mounted.

FIGS. 42 to 43 each illustrate the positional data acquisition positions Pb of the right lidar and the positional data acquisition positions Pc of the left lidar. As described above, according to the conventional technology, the side surface of the building b on the left side is the measurement impossible region

a r^{†}
(refer to FIG. 42 in comparison with FIG. 20), and the side surface of the building b on the right side is the measurement low-accuracy region
a r^{‡}
(refer to FIG. 42 in comparison with FIG. 20). As described above, the measurement impossible region
a r^{†}
is, for example, a region that is a blind spot when viewed in the position of a lidar and in which measurement by the MMS is difficult because no laser beam is incident. The measurement low-accuracy region
a r^{‡}
is, for example, a region in which the accuracy of measurement by the MMS decreases as the interval of laser beam irradiation increases (the measurement density decreases) because the region is positioned nearly in parallel to a measurement surface. In FIG. 43, which corresponds to FIG. 21 for description of the conventional technology, illustrations of the measurement impossible region
a r^{†}
and the measurement low-accuracy region
a r^{‡}
are omitted to avoid complication of the drawing.

As illustrated in FIG. 42, according to the present embodiment, a measurement surface constituted by positional data acquisition positions Pb and a measurement surface constituted by positional data acquisition positions Pc are two surfaces tilted relative to a cross-section (surface orthogonal to the traveling direction of the vehicle 1) in the right-left direction of the vehicle 1 (x-axis direction), and thus a laser beam is incident on the measurement impossible region

a r^{†},
measurement of which is difficult with the conventional technology. Accordingly, the measurement impossible region is reduced as compared to conventional cases. Moreover, according to the present embodiment, a laser beam is incident at a higher measurement density on the measurement low-accuracy region
a r^{‡},
in which the measurement density is low and the accuracy of measurement decreases with the conventional technology. Accordingly, the measurement low-accuracy region is reduced as compared to conventional cases.

[Functional Configuration of MMS]

The configuration of an MMS 10 will be described below. FIG. 44 is a block diagram illustrating a functional configuration of the MMS 10 according to the first embodiment of the present invention. The MMS 10 (measurement device) is achieved by an information processing device such as a general-purpose computer. The MMS 10 is mounted on a movable body such as the above-described vehicle 1. While moving along a movement path (for example, the road R), the movable body measures the position of an object that exists in surroundings of the movement path, and outputs point group data. As illustrated in FIG. 44, the MMS 10 includes a measurement unit 101, a storage unit 102, a point group data generation unit 103, and a point group data output unit 104.

The measurement unit 101 includes a measurement instrument such as a lidar. The measurement unit 101 measures the position of an object in surroundings of the movement path of the movable body. The measurement unit 101 measures the position of the object with a plurality of measurement surfaces as measurement targets, the plurality of measurement surfaces facing in directions different from each other. The measurement unit 101 generates positional data representing a result of the measurement.

For example, the generated positional data includes positional data obtained by, for example, a right lidar included in the measurement unit 101, and positional data obtained by, for example, a left lidar included in the measurement unit 101. Specifically, for example, the measurement unit 101 performs position measurement for positional data acquisition positions (for example, positional data acquisition positions Pb and positional data acquisition positions Pc described above) existing on a plurality of measurement surfaces tilted with respect to a surface (cross-section) orthogonal to the traveling direction of the movable body in the right-left direction of the traveling direction of the movable body.

The measurement unit 101 stores the generated positional data in the storage unit 102. When (for example, movement of the movable body along the movement path ends and) all measurement on a measurement target range is completed, the measurement unit 101 may output information indicating completion of the measurement to the point group data generation unit 103. The measurement unit 101 may be included in a device outside the MMS 10.

The storage unit 102 stores point group data as a set of the positional data. The storage unit 102 is achieved by, for example, a storage medium such as a flash memory, a hard disk drive (HDD), a solid state drive (SDD), a random access memory (RAM; readable-writable memory), an electrically erasable programmable read only memory (EEPROM), or a register, or a combination of these storage media. The storage unit 102 may be included in a device outside the MMS 10.

The point group data generation unit 103 recognizes completion of the measurement by the measurement unit 101 by acquiring, for example, the above-described information indicating completion of the measurement and output from the measurement unit 101. When having recognized completion of the measurement, the point group data generation unit 103 generates point group data of an object in surroundings of the movement path of the movable body by using the positional data stored in the storage unit 102. The point group data generation unit 103 stores the generated point group data in the storage unit 102. When generation of the point group data is completed, the point group data generation unit 103 may output information indicating completion of the generation to the point group data output unit 104.

The point group data output unit 104 recognizes completion of the point group data generation by acquiring, for example, the above-described information indicating completion of the generation and output from the point group data generation unit 103. When having recognized completion of the point group data generation, the point group data output unit 104 outputs the point group data stored in the storage unit 102 to a device (such as an external device) configured to perform processing after the MMS 10.

[Operation of MMS]

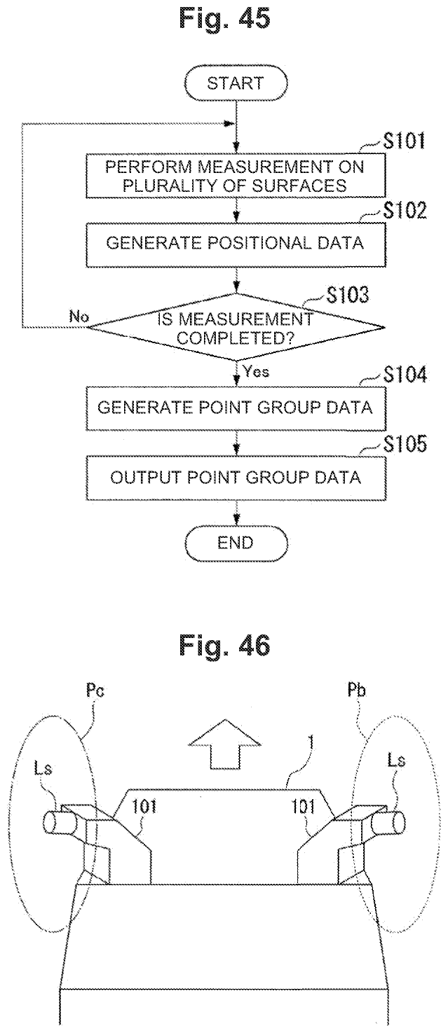

Exemplary operation of the MMS 10 (measurement device) will be described below. FIG. 45 is a flowchart illustrating operation of the MMS 10 according to the first embodiment of the present invention.

The measurement unit 101 measures the position of an object in surroundings of the movement path of the movable body. The measurement unit 101 measures the position of the object with a plurality of measurement surfaces as measurement targets, the plurality of measurement surfaces facing in directions different from each other (step S101). The measurement unit 101 generates positional data representing a result of the measurement (step S102). The measurement unit 101 stores the generated positional data in the storage unit 102. The measurement unit 101 continues the above-described measurement until all measurement on a measurement target range is completed.

When all measurement on the measurement target range by the measurement unit 101 is completed (Yes at step S103), the point group data generation unit 103 generates point group data of the object in surroundings of the movement path of the movable body by using the positional data stored in the storage unit 102 (step S104). The point group data generation unit 103 stores the generated point group data in the storage unit 102.

When the point group data generation by the point group data generation unit 103 is completed, the point group data output unit 104 outputs the point group data stored in the storage unit 102 to a device (such as an external device) configured to perform processing after the MMS 10 (step S105). This ends the operation of the MMS 10 illustrated in the flowchart of FIG. 45.

When coordinates indicated by pieces of the positional data obtained by measurement on a plurality of measurement surfaces (for example, a coordinate indicated by the positional data obtained by the right lidar and a coordinate indicated by the positional data obtained by the left lidar) are positioned close to each other, the MMS 10 may delete pieces of the positional data other than one piece. Reasons for this are as follows.

Typically, the MMS performs processing on a large amount of positional data all at once. When coordinates indicated by a plurality of (for example, two) pieces of positional data are positioned close to each other, the MMS 10 deletes one of the pieces of positional data, and accordingly, the plurality of pieces of positional data are regarded as same information and collected as one piece of positional data. The first reason is because the data amount of point group data is reduced since the plurality of pieces of positional data are collected as one piece of positional data, and a processing load at the MMS 10 is reduced.

Point group data generated based on positional data obtained by measurement on a plurality of measurement surfaces contains positional data acquired in duplication for a nearby coordinate and positional data obtained by measurement on any one of a plurality of measurement surfaces. Accordingly, disadvantage occurs in some cases when point group data output from the MMS 10 is utilized by, for example, a device configured to perform processing after the MMS 10. For example, typically, the point group data includes no information corresponding to volume, and thus processing of weighting on the density of positional data acquisition is performed for each measurement target region in some cases.

However, as described above, when coordinates indicated by a plurality of pieces of positional data exist close to each other and processing of deleting one of the pieces of positional data is not performed, the MMS 10 needs to redundantly perform processing of providing weights different from each other on positional data acquired in duplication for a nearby coordinate and positional data obtained by measurement on any one measurement surface. The second reason is because a load on the MMS 10 is reduced in such processing of weighting on the density of positional data acquisition.

Whether a plurality of coordinates are positioned close to each other is determined based on, for example, whether the distance therebetween is shorter than a resolution interval of a lidar. The resolution interval is a measurable space size. Specifically, it is determined that two coordinate valuable are approximate to each other, for example, when a measurable space including the position (positional data acquisition position Pb) of positional data acquisition through measurement by the right lidar includes the position (positional data acquisition position Pc) of positional data acquisition through measurement by the left lidar.

When a plurality of pieces of positional data having coordinates positioned close to each other are replaced with one piece of positional data through the above-described processing, a device configured to perform processing after the MMS 10 can utilize, as typical point group data, point group data output from the MMS 10.

[Configuration of Measurement Unit]

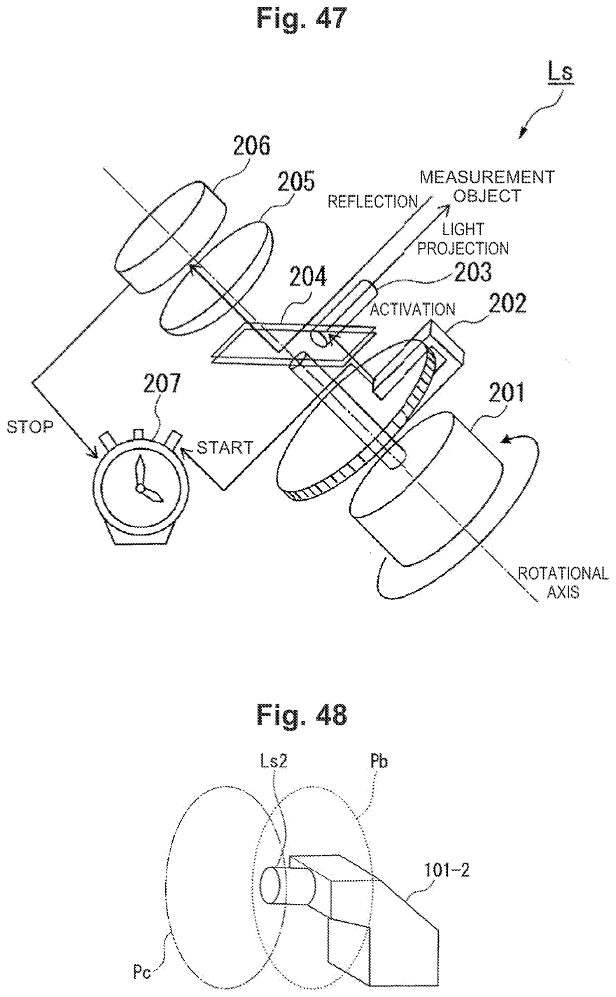

An exemplary hardware configuration of the measurement unit 101 will be described below. FIGS. 46 and 47 are each a schematic diagram illustrating the configuration of the measurement unit 101 according to the first embodiment of the present invention.

As illustrated in FIG. 46, each measurement unit 101 including a lidar Ls is installed on the roof of the vehicle 1. The measurement units 101 are installed at right and left corners of a back part on the roof. The measurement unit 101 at the right corner is installed in an orientation with which a measurement surface constituted by positional data acquisition positions Pb, as a measurement target of the corresponding lidar Ls (right lidar), is tilted rightward with respect to a cross-section orthogonal to the traveling direction of the vehicle 1. The measurement unit 101 at the left corner is installed in an orientation with which a measurement surface constituted by positional data acquisition positions Pc, as a measurement target of the corresponding lidar Ls (left lidar), is tilted leftward with respect to the cross-section orthogonal to the traveling direction of the vehicle 1.

FIG. 47 is a diagram illustrating an optical internal structure of each lidar Ls included in the corresponding measurement unit 101 according to the first embodiment of the present invention. The right and left lidars have the same optical internal structure. As illustrated in FIG. 47, each lidar Ls includes a motor 201, an angle encoder 202, a light projector 203, a reflection mirror 204, a light condensation lens 205, a light receiver 206, and a stopwatch 207.

The motor 201 (rotation mechanism) rotates at a constant speed about a rotational axis illustrated in FIG. 47 when measurement by the measurement unit 101 is performed. The angle encoder 202 generates an activation signal (such as a pulse signal) at a constant interval. The angle encoder 202 outputs the activation signal to the light projector 203 and the stopwatch 207. The light projector 203 and the reflection mirror 204 rotate in synchronization with rotation of the motor 201. When having acquired the activation signal output from the angle encoder, the light projector 203 projects a laser beam. When having acquired the activation signal output from the light projector 203, the stopwatch 207 starts timekeeping. The light projector 203 may output the activation signal to the stopwatch 207 when having acquired the activation signal output from the angle encoder.

The laser beam projected by the light projector 203 is reflected by a measurement object and returned to the lidar Ls as reflected light. The reflection mirror 204 refracts the traveling direction of the reflected light to the light condensation lens 205. The light receiver 206 (light reception unit) receives the reflected light through the light condensation lens 205. The stopwatch 207 stops the timekeeping when the reflected light is received by the light receiver 206.

The measurement unit 101 specifies the direction of the measurement target based on a signal output from the angle encoder 202. In addition, the measurement unit 101 calculates the distance to the measurement object based on a time measured by the stopwatch. The measurement unit 101 generates positional data representing the position of the measurement object based on the specified direction and the calculated distance.

As described above, the MMS 10 according to the first embodiment of the present invention acquires positional data for positional data acquisition positions (such as positional data acquisition positions Pb and positional data acquisition positions Pc described above) existing on a plurality of measurement surfaces tilted in the right-left direction of the vehicle 1 with respect to a surface (cross-section) orthogonal to the traveling direction of the vehicle 1.

The MMS 10 can measure a measurement insensible region and a measurement impossible region, which cannot be measured in conventional cases, by acquiring and analyzing the positional data obtained as described above. In addition, the MMS 10 can measure a measurement low-accuracy region, in which the measurement density decreases and the accuracy of measurement decreases in conventional cases, at a higher measurement density by acquiring and analyzing the positional data obtained as described above. Accordingly, the MMS 10 according to the present embodiment can reduce a region in which measurement is impossible and a region in which the accuracy of measurement decreases.

### Modification of First Embodiment

A modification of the first embodiment of the present invention will be described below with reference to the accompanying drawings.

The MMS 10 according to the first embodiment described above includes one measurement unit 101 for each measurement surface, but may include only one measurement unit (such as a measurement unit 101-2 described below) capable of performing measurement for a plurality of measurement surfaces.

[Configuration of Measurement Unit]

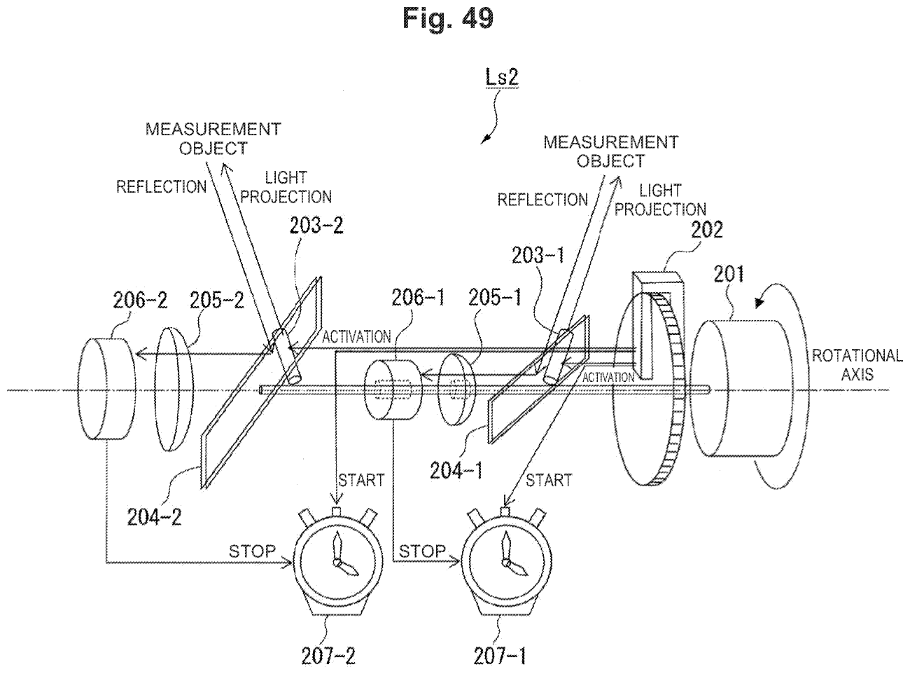

An exemplary hardware configuration of the measurement unit 101-2 will be described below. FIGS. 48 and 49 are each a schematic diagram illustrating the configuration of the measurement unit 101-2 according to the modification of the first embodiment of the present invention.

The measurement unit 101-2 is installed at, for example, a central position of a back part on the roof of the vehicle 1. As illustrated in FIG. 48, the measurement unit 101-2 includes a lidar Ls2. The lidar Ls2 can perform measurement on both positional data acquisition positions Pb and positional data acquisition positions Pc. As described above, a measurement surface constituted by the positional data acquisition positions Pb and a measurement surface constituted by the positional data acquisition positions Pc have tilts different from each other with respect to the traveling direction of the vehicle 1.

FIG. 49 is a diagram illustrating an optical internal structure of the lidar Ls2 included in the measurement unit 101-2 according to the modification of the first embodiment of the present invention. As illustrated in FIG. 49, the lidar Ls2 includes the motor 201, the angle encoder 202, a light projector 203-1, a light projector 203-2, a reflection mirror 204-1, a reflection mirror 204-2, a light condensation lens 205-1, a light condensation lens 205-2, a light receiver 206-1, a light receiver 206-2, a stopwatch 207-1, and a stopwatch 207-2.

Accordingly, a light projector, a reflection mirror, a light condensation lens, a light receiver, and a stopwatch are provided for each measurement surface. For example, the light projector 203-1, the reflection mirror 204-1, the light condensation lens 205-1, the light receiver 206-1, and the stopwatch 207-1 are members for performing measurement on the positional data acquisition positions Pb. For example, the light projector 203-2, the reflection mirror 204-2, the light condensation lens 205-2, the light receiver 206-2, and the stopwatch 207-2 are members for performing measurement on the positional data acquisition positions Pc.

The light projector 203-1 projects a laser beam toward each positional data acquisition position Pb. The reflection mirror 204-1 refracts, to the light condensation lens 205-1, the traveling direction of reflected light of the laser beam projected by the light projector 203-1. The light projector 203-2 projects a laser beam toward each positional data acquisition position Pc. The reflection mirror 204-2 refracts, to the light condensation lens 205-2, the traveling direction of reflected light of the laser beam projected by the light projector 203-2.

Any other mechanism of each component is same as a mechanism of the corresponding component in the lidar Ls according to the first embodiment described above, and thus description thereof is omitted.

The motor 201 and the angle encoder 202 are common members used for both measurement on the positional data acquisition positions Pb and measurement on the positional data acquisition positions Pc. Since the motor 201 and the angle encoder 202 are common members, a measurement error between measurement on the positional data acquisition positions Pb and measurement on the positional data acquisition positions Pc is reduced.

When a stopwatch capable of measuring a lap time (performing halfway timekeeping) is used, the stopwatch may be used as a common member. In this case, since the angle encoder 202 and the stopwatch are both common members, measurement on two measurement objects can be performed on one time axis, and thus the above-described measurement error is further reduced.

[Operation of Lidar]

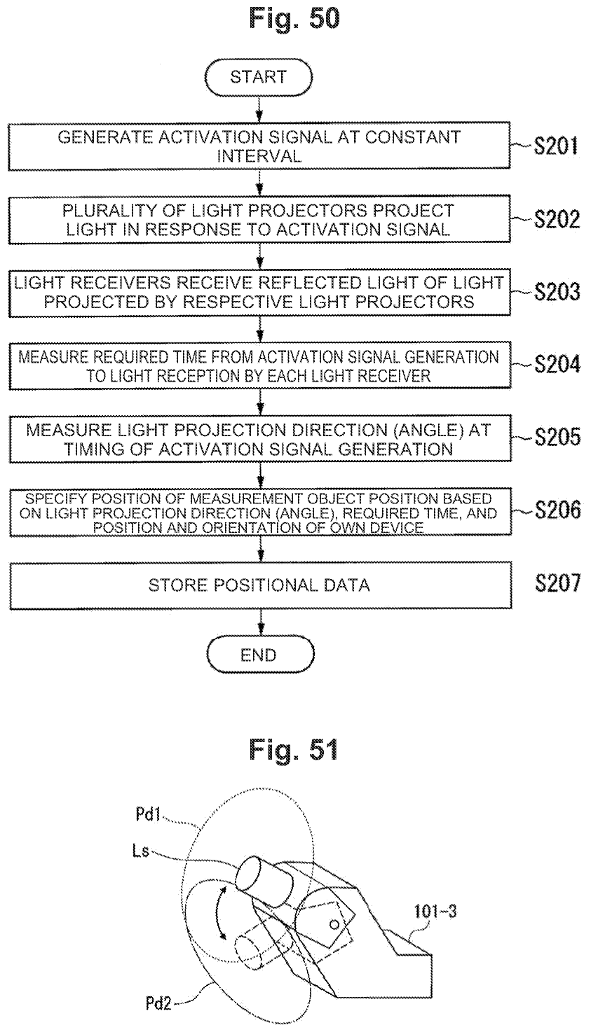

Exemplary operation of the lidar Ls2 will be described below. FIG. 50 is a flowchart illustrating operation of the lidar Ls2 according to the modification of the first embodiment of the present invention.

The angle encoder 202 generates an activation signal at a constant interval (step S201). A plurality of light projectors (the light projector 203-1 and the light projector 203-2) project light in response to the activation signal (step S202). Reflected light of the light projected by each light projector is received by the corresponding light receiver (step S203). Specifically, the light receiver 206-1 receives, through the reflection mirror 204-1 and the light condensation lens 205-1, reflected light of the laser beam projected by the light projector 203-1. The light receiver 206-2 receives, through the reflection mirror 204-2 and the light condensation lens 205-2, reflected light of the laser beam projected by the light projector 203-2.

The measurement unit 101 measures a required time from generation of the activation signal to light reception by each light receiver (step S204). Specifically, the measurement unit 101 measures, with the stopwatch 207-1, the required time from generation of the activation signal to light reception by the light receiver 206-1, and measures, with the stopwatch 207-2, the required time from generation of the activation signal to light reception by the light receiver 206-2.

The measurement unit 101 measures, with the angle encoder 202, the direction (angle) of light projection by each light projector (the light projector 203-1 or the light projector 203-2) at the timing of generation of the activation signal (step S205). The measurement unit 101 specifies the position of a measurement object based on the light projection direction (angle), the required time, and the position and orientation of the own device (step S206). The measurement unit 101 stores positional data representing the specified position of the measurement object in the storage unit 102 (step S207).

This ends the operation of the lidar Ls2 illustrated in the flowchart of FIG. 50. The subsequent operation of the MMS 10 is same as the operation (operation at step S103 in FIG. 45 and later) of the MMS 10 according to the first embodiment described above.

For easiness of comparison with the first embodiment, the modification of the first embodiment described above is described above on a case in which the orientations of two measurement surfaces are different from each other in the right-left direction of the vehicle 1 (x-axis direction) as illustrated in FIG. 48. However, the present invention is not limited to this configuration, but may have, for example, a configuration in which the orientations of two measurement surfaces are different from each other in the vertical direction (z-axis direction) (in other words, a configuration in which two measurement surfaces each have an elevation angle and a depression angle). In this case, effects same as effects of an MMS according to a second embodiment to be described later can be obtained.

### Second Embodiment

The second embodiment of the present invention will be described below with reference to the accompanying drawings.

In the first embodiment and the modification of the first embodiment described above, one measurement unit can project laser beams in directions on one or a plurality of predetermined measurement surfaces. In other words, as illustrated in FIG. 46, the measurement unit 101 in the first embodiment is a fixed measurement unit configured to perform measurement only on one predetermined measurement surface (measurement surface constituted by positional data acquisition positions Pb or measurement surface constituted by positional data acquisition positions Pc). As illustrated in FIG. 48, the measurement unit 101-2 in the modification of the first embodiment is a fixed measurement unit configured to perform measurement only on two predetermined measurement surfaces (the measurement surface constituted by positional data acquisition positions Pb and the measurement surface constituted by positional data acquisition positions Pc).

However, a measurement unit 101-3 according to the second embodiment describes below is a movable measurement unit capable of changing the projection direction of a laser beam with time.

[Configuration of Measurement Unit]

An exemplary configuration of the measurement unit 101-3 will be described below. FIG. 51 is a schematic diagram illustrating the configuration of the measurement unit 101-3 according to a modification of the second embodiment of the present invention.

As illustrated in FIG. 51, the measurement unit 101-3 includes a lidar Ls. An optical internal mechanism of the lidar Ls is same as the internal structure of the lidar Ls according to the first embodiment illustrated in FIG. 47. The measurement unit 101-3 can change the orientation of the lidar Ls in elevation and depression angle directions. For example, the measurement unit 101-3 can perform measurement on a measurement surface constituted by positional data acquisition positions Pd1 when the orientation of the lidar Ls is most tilted in the elevation angle direction. For example, the measurement unit 101-3 can perform measurement on a measurement surface constituted by positional data acquisition positions Pd2 when the orientation of the lidar Ls is most tilted in the depression angle direction.

The measurement unit 101-3 can perform measurement on a measurement surface having optional elevation and depression angles, but for simplification of the following description, it is assumed that measurement is performed on two surfaces illustrated in FIG. 51, namely, the measurement surface constituted by positional data acquisition positions Pd1 and the measurement surface constituted by positional data acquisition positions Pd2. When performing measurement, the measurement unit 101-3 changes the orientation of the lidar Ls to reciprocate in the elevation and depression angle directions in a constant period. Accordingly, the measurement unit 101-3 can acquire positional data for the positional data acquisition positions Pd1 and positional data for the positional data acquisition positions Pd2 at constant intervals.

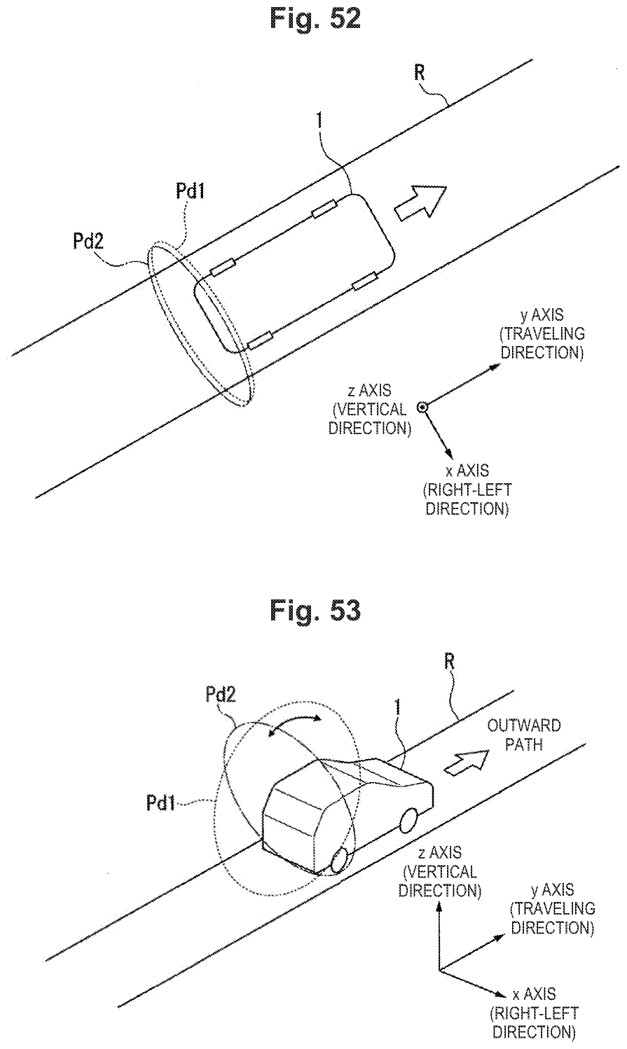

FIGS. 52 to 54 are each a schematic diagram illustrating the position of positional data acquisition by an MMS according to the second embodiment of the present invention. The vehicle 1 travels on the road R along a predetermined movement path. FIGS. 52 to 54 illustrate a horizontal view, a bird's eye view, and a vertical cross-sectional view, respectively, of a space in which the vehicle 1 exists at a time point during the traveling, the MMS being mounted on the vehicle 1.

The measurement unit 101-3 including the lidar Ls illustrated in FIG. 51 is mounted at the back part of the vehicle 1. The measurement unit 101-3 is installed at, for example, a central position of the back part on the roof of the vehicle 1, facing in a direction opposite to the traveling direction of the vehicle 1. The MMS measures, through the lidar Ls, surroundings of the road R on which the vehicle 1 travels, and acquires the positional data of an object that exists in surroundings of the road R.

In FIGS. 52 to 54, a dotted line represents positional data acquisition positions Pd1 as a set of acquisition positions of positional data acquired by the MMS when the orientation of the lidar Ls is most tilted in the elevation angle direction. In FIGS. 52 to 54, a dashed and single-dotted line represents positional data acquisition positions Pd2 as a set of acquisition positions of positional data acquired by the MMS when the orientation of the lidar Ls is most tilted in the depression angle direction.

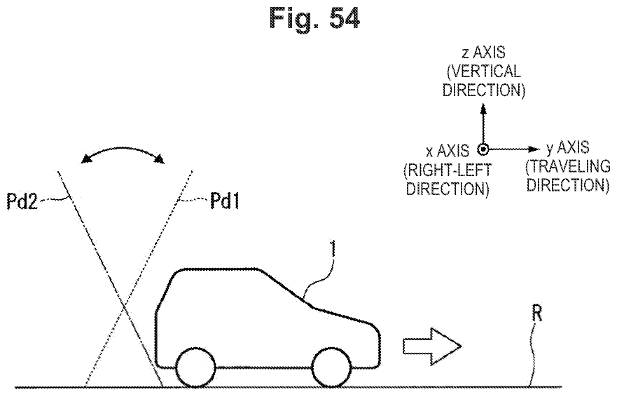

As understood from the vertical cross-sectional view of FIG. 54, the measurement surface constituted by positional data acquisition positions Pd1 has a depression angle with respect to the cross-section orthogonal to the traveling direction of the vehicle 1. The measurement surface constituted by positional data acquisition positions Pd2 has an elevation angle with respect to the cross-section orthogonal to the traveling direction of the vehicle 1. Accordingly, as understood from the vertical cross-sectional view of FIG. 54, the measurement surface constituted by the positional data acquisition positions Pd1 and the measurement surface constituted by the positional data acquisition positions Pd2 intersect each other.

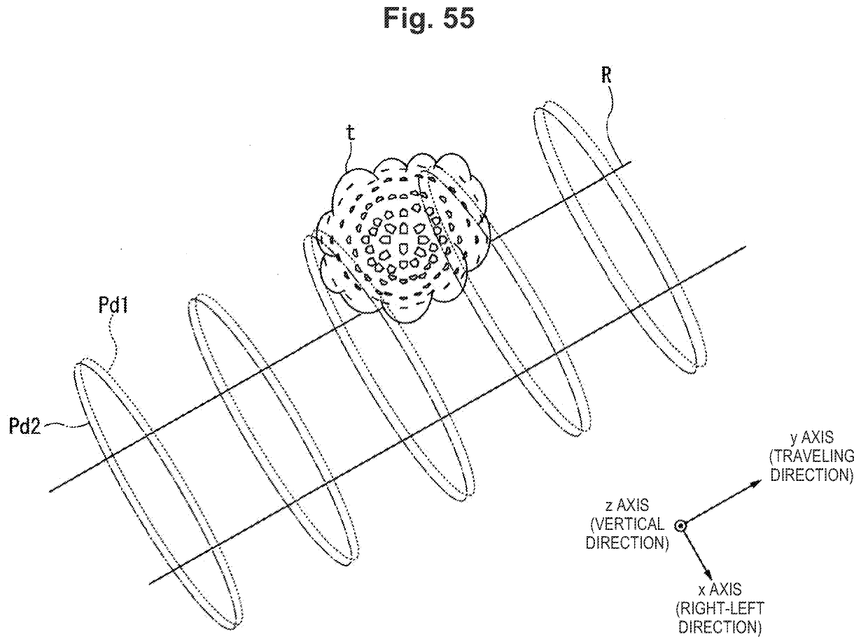

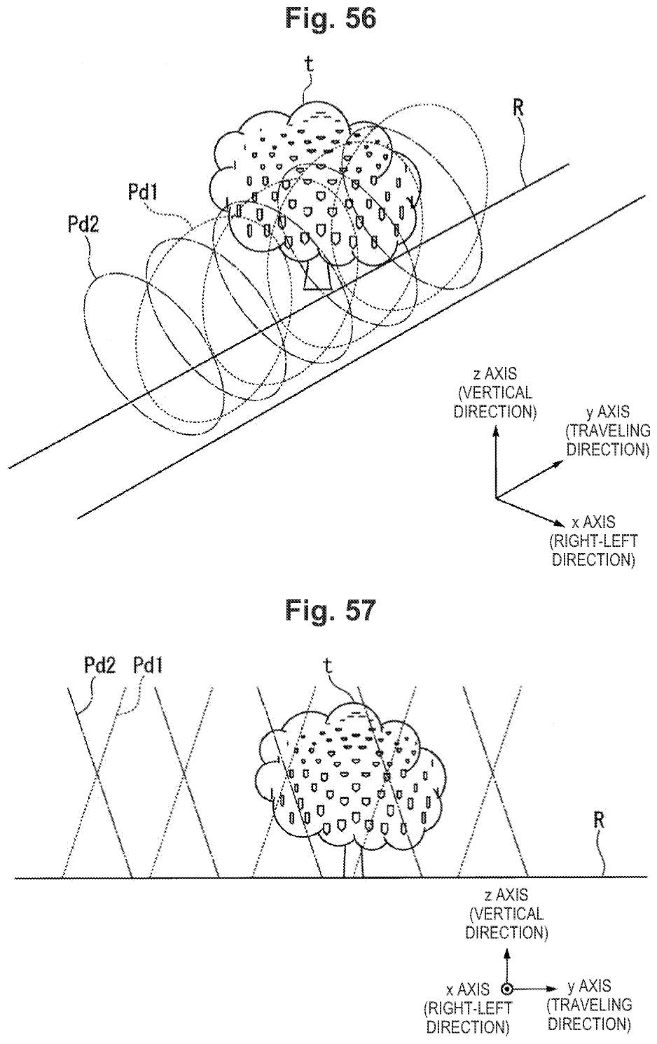

FIGS. 55 to 57 are each a schematic diagram illustrating exemplary measurement by the MMS according to the second embodiment of the present invention. FIGS. 55 to 57 illustrate a horizontal view, a bird's eye view, and a vertical cross-sectional view, respectively, of a space traveled by the vehicle 1 on which the MMS configured to measure surroundings of the road R is mounted.

The vehicle 1 travels on the road R at a constant speed. Accordingly, the MMS mounted on the vehicle 1 can acquire, for an object that exists in surroundings of the road R, positional data for the positional data acquisition positions Pd1 and the positional data acquisition positions Pd2 at constant intervals. For example, as illustrated in FIGS. 55 to 57, one tree t exists on the left side of the road R with respect to the traveling direction of the vehicle 1. The MMS acquires the positional data of the tree t when passing by the tree t.

FIGS. 55 to 57 each illustrate all positional data acquisition positions Pd1 and all positional data acquisition positions Pd2 as measurement targets when the vehicle 1 travels on the road R. As understood from the horizontal view of FIG. 55 and the vertical cross-sectional view of FIG. 57, two measurement surfaces constituted by positional data acquisition positions Pd1 and two measurement surfaces constituted by positional data acquisition positions Pd2 overlap the tree t.

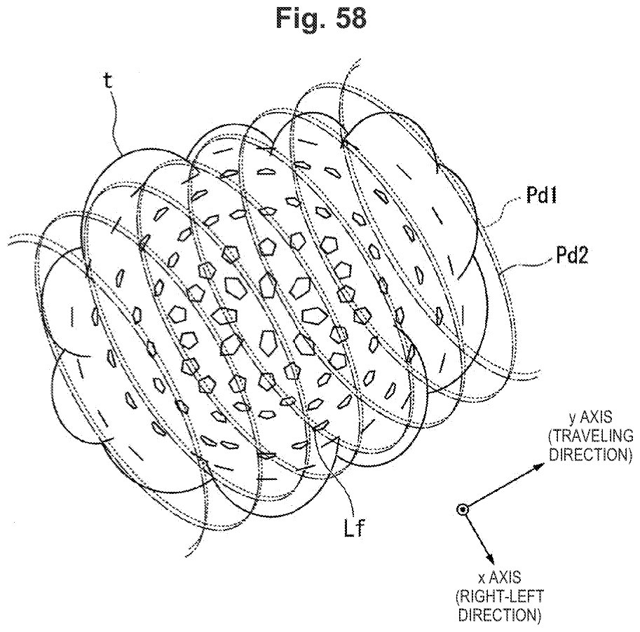

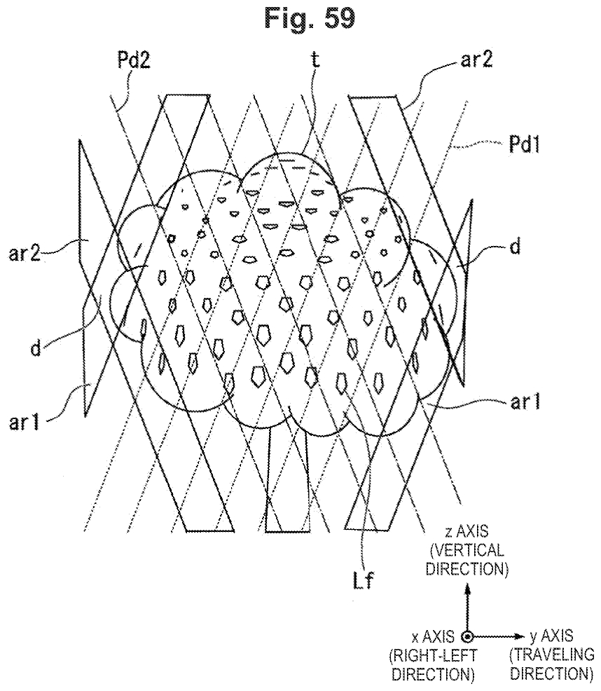

FIGS. 58 and 59 are each a schematic diagram for description of a measurement insensible region when a measurement object is a tree. FIGS. 58 and 59 illustrate a horizontal view and a vertical cross-sectional view, respectively, of a tree t and its surroundings, the tree t existing in a space traveled by the vehicle 1 on which the MMS configured to measure surroundings of the road R is mounted.

As illustrated in FIGS. 58 and 59, the tree t has a large number of leaves Lf as positional data acquisition targets. FIGS. 58 and 59 each illustrate positional data acquisition positions Pd1 and positional data acquisition positions Pd2 as measurement targets when the vehicle 1 travels on the road R. As illustrated in FIG. 59, measurement insensible regions are generated on the side in the traveling direction of the vehicle 1 and on the side in the direction opposite thereto (front and back sides in the y-axis direction) in the tree t. As described above, a measurement insensible region is a region in which measurement by the MMS is difficult. Illustrations of the measurement insensible regions are omitted in FIG. 58 to avoid complication of the drawing.

As illustrated in FIG. 59, a measurement insensible region ar1 is a measurement insensible region generated at acquisition of positional data for the positional data acquisition positions Pd1. A measurement insensible region ar2 is a measurement insensible region generated at acquisition of positional data for the positional data acquisition positions Pd2. The measurement insensible region ar1 and measurement insensible region ar2 are generated on each of the side in the traveling direction of the vehicle 1 and the side in the direction opposite thereto (front and back sides in the y-axis direction), respectively, in the tree t, and thus there are the two measurement insensible regions ar1 and the two measurement insensible regions ar2.

As illustrated in FIG. 59, the measurement insensible regions ar1 and the measurement insensible regions ar2 each have an elevation angle and a depression angle with respect to the cross-section, and thus intersect each other. Accordingly, as illustrated in FIG. 59, an overlapping region d is generated on each of the side in the traveling direction of the vehicle 1 and the side in the direction opposite thereto (front and back sides in the y-axis direction) in the tree t.

A range that is not an overlapping region d in each measurement insensible region ar1 is a region that is not a measurement insensible region ar2. Thus, this region is a region in which positional data acquisition is difficult when measurement is performed on the measurement surface constituted by the positional data acquisition positions Pd1, but the region is a region in which positional data acquisition is possible when measurement is performed on the measurement surface constituted by the positional data acquisition positions Pd2. A range that is not an overlapping region d in each measurement insensible region ar2 is a region that is not a measurement insensible region ar1. Thus, this region is a region in which positional data acquisition is difficult when measurement is performed on the measurement surface constituted by the positional data acquisition positions Pd2, but the region is a region in which positional data acquisition is possible when measurement is performed on the measurement surface constituted by the positional data acquisition positions Pd1.

In this manner, according to the present embodiment, measurement on the positional data acquisition positions Pd1 and measurement on the positional data acquisition positions Pd2 complement each other, and thus each overlapping region d is only a region in which positional data acquisition is difficult in each measurement. When measurement surfaces are a surface having an elevation angle and a surface having a depression angle with respect to the cross-section as a surface orthogonal to the traveling direction of the vehicle 1, a measurement insensible region is significantly reduced as compared to conventional cases as illustrated in, for example, FIG. 59. Accordingly, the probability of occurrence of false recognition that the MMS recognizes the width of the tree t to be smaller than the actual width due to generation of a measurement insensible region is significantly decreased as compared to conventional cases.

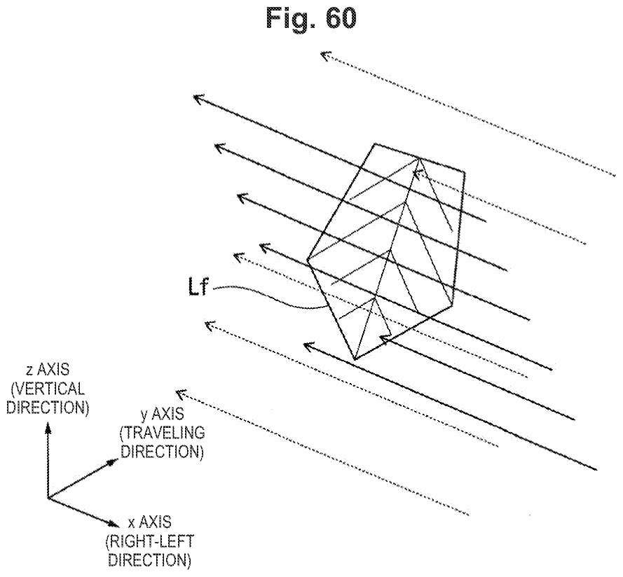

FIGS. 60 to 62 are each a schematic diagram illustrating the relation between the orientation of a leaf Lf and the direction of laser beam emission by the lidar Ls. In FIGS. 60 to 62, each solid line arrow and each dotted line arrow represent laser beam emission. Distinction between the solid line arrow and the dotted line arrow is based on difference in the acquisition timing of positional data. Specifically, the solid line arrow represents each laser beam emission to a positional data acquisition position Pd1 (or positional data acquisition position Pd2) at an acquisition timing. The dotted line arrow represents each laser beam emission to a positional data acquisition position Pd1 (or positional data acquisition position Pd2) at an acquisition timing different from the above-described acquisition timing.

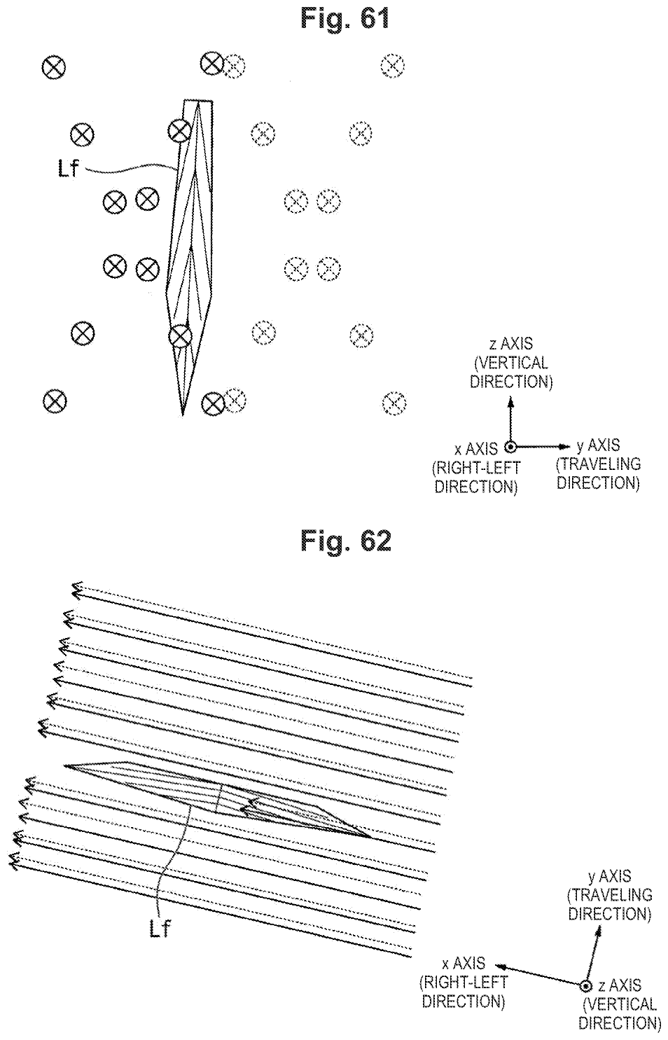

In FIG. 61, each mark with “X” illustrated in a circle corresponds to an arrow in FIGS. 60 and 62. The mark indicates laser beam emission into the drawing. As illustrated in FIG. 61, the marks include marks arranged in two lines from the upper-left side toward the lower-right side in the drawing, and marks arranged in two lines from the upper-right side toward the lower-left side in the drawing. The marks arranged from the upper-right side toward the lower-left side in the drawing represent laser beams emitted to the positional data acquisition positions Pd1. The marks arranged from the upper-left side toward the lower-right side in the drawing represent laser beams emitted to the positional data acquisition positions Pd2.

Distinction between a mark illustrated with a solid line and a mark illustrated with a dotted line is based on difference in the acquisition timing of positional data. Specifically, the solid line mark represents each laser beam emission to a positional data acquisition position Pd1 (or positional data acquisition position Pd2) at an acquisition timing. The dotted line mark represents each laser beam emission to a positional data acquisition position Pd1 (or positional data acquisition position Pd2) at an acquisition timing different from the above-described acquisition timing.

FIGS. 60 to 62 illustrate a bird's eye view, a vertical cross-sectional view, and a horizontal view, respectively, of the leaf Lf growing in a tree t and its surroundings, the tree t existing in a space traveled by the vehicle 1 on which the MMS configured to measure surroundings of the road R is mounted. The orientation of the front surface of the leaf Lf illustrated in FIGS. 60 to 62 is same as the orientation of the front surface of the leaf Lf illustrated in FIGS. 17 to 19, respectively.

In FIGS. 17 to 19, the leaf Lf is unlikely to be irradiated with a laser beam emitted by the lidar. However, according to the present embodiment, as illustrated in FIGS. 60 to 62, measurement is performed on measurement surfaces (such as a measurement surface constituted by positional data acquisition positions Pd1 and a measurement surface constituted by positional data acquisition positions Pd1) having elevation angles different from each other and depression angles different from each other. This increases the probability that a laser beam emitted by the lidar Ls is incident on the leaf Lf in an orientation with which the laser beam is unlikely to be incident in conventional cases. Accordingly, it is possible to acquire the positional data of the leaf Lf, which cannot be acquired in conventional cases.

According to the present embodiment, the probability that a laser beam is incident on the leaf Lf is high when the orientation of the front surface of the leaf Lf is the orientation illustrated in FIGS. 60 to 62 and the position of the leaf Lf is at a height different from that of the position of the lidar Ls. This is because, since a measurement surface has an elevation angle or a depression angle, the emission direction of a laser beam includes a component in the traveling direction of the vehicle 1 or the direction opposite thereto (front or back direction along the y-axis direction) when the emission direction of the laser beam is a direction different from the height of the position of the lidar Ls.

Moreover, as difference between the height of the position of the leaf Lf and the height of the position of the lidar Ls increases, the emission direction of a laser beam includes a larger amount of a component in the traveling direction of the vehicle 1 or the direction opposite thereto (front or back direction along the y-axis direction), and thus the probability that the laser beam is incident on the leaf Lf becomes higher.

For example, when the measurement unit 101-3 including the lidar Ls is mounted on the roof of the vehicle 1, positional data acquisition positions Pd1 or positional data acquisition positions Pd2 acquired by the MMS are positioned not on the cross-section (x-z plane) as a surface orthogonal to the traveling direction of the vehicle 1 (y-axis direction) but on a measurement surface having an elevation angle or a depression angle with respect to the traveling direction (the y-axis direction). Accordingly, the emission direction of a laser beam to a measurement object that exists at a position higher than the height of the roof at the vehicle position (in other words, the installation height of the lidar Ls) includes a component in the direction (negative direction along the y-axis direction) opposite to the traveling direction of the vehicle 1. However, the emission direction of a laser beam to a measurement object that exists at a position lower than the height of the roof at the vehicle position includes a component in the traveling direction of the vehicle 1 (positive direction along the y-axis direction).

Specifically, when emitted toward a position at a height same as that of the position of the lidar Ls, a laser beam is emitted in the direction orthogonal to the traveling direction of the vehicle 1 (x-axis direction). However, when emitted toward a position higher than the position of the lidar Ls, a laser beam is emitted in a direction obliquely upward on the back side of the vehicle 1 (when a measurement surface has an elevation angle). When emitted toward a position lower than the position of the lidar Ls, a laser beam is emitted in a direction obliquely downward on the front side of the vehicle 1 (when a measurement surface has a depression angle). Accordingly, when the position of the leaf Lf growing with a side surface facing the vehicle 1 and the position of the lidar Ls are at heights different from each other, a laser beam is emitted in a direction including a component in the front or back direction of the vehicle 1, and thus the probability that the laser beam is incident on the leaf Lf is high.

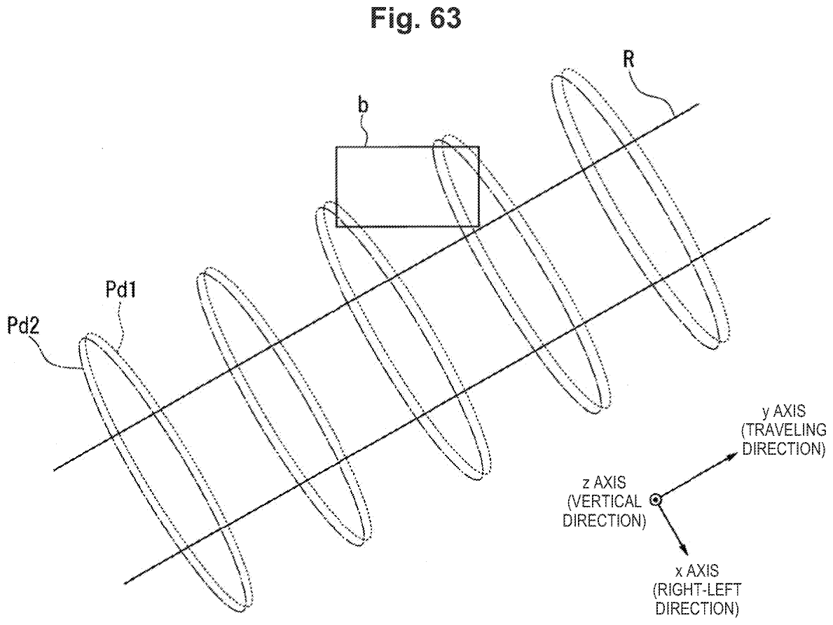

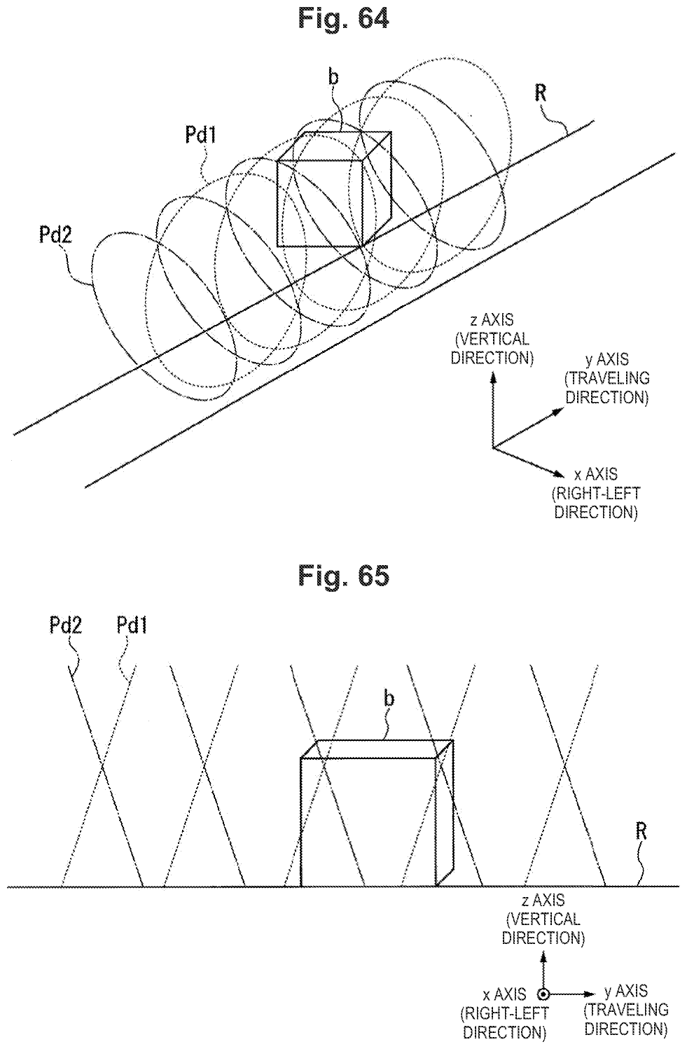

Similarly to FIGS. 55 to 57, FIGS. 63 to 65 are each a schematic diagram illustrating exemplary measurement by the MMS according to the second embodiment of the present invention. FIGS. 63 to 65 illustrate a horizontal view, a bird's eye view, and a vertical cross-sectional view, respectively, of a space traveled by the vehicle 1 on which the MMS configured to measure surroundings of the road R is mounted.

The vehicle 1 travels on the road R at a constant speed. Accordingly, the MMS mounted on the vehicle 1 can acquire, for an object that exists in surroundings of the road R, positional data for positional data acquisition positions Pd1 and the positional data acquisition positions Pd2 at constant intervals. For example, as illustrated in FIGS. 63 to 65, one building d exists on the left side of the road R with respect to the traveling direction of the vehicle 1. The MMS acquires the positional data of the building d when passing by the building d.

FIGS. 63 to 65 each illustrate all positional data acquisition positions Pd1 and all positional data acquisition positions Pd2 as measurement targets when the vehicle 1 travels on the road R. As understood from the horizontal view of FIG. 63 and the vertical cross-sectional view of FIG. 65, two measurement surfaces constituted by positional data acquisition positions Pd1 and two measurement surfaces constituted by positional data acquisition positions Pd2 overlap the building d.

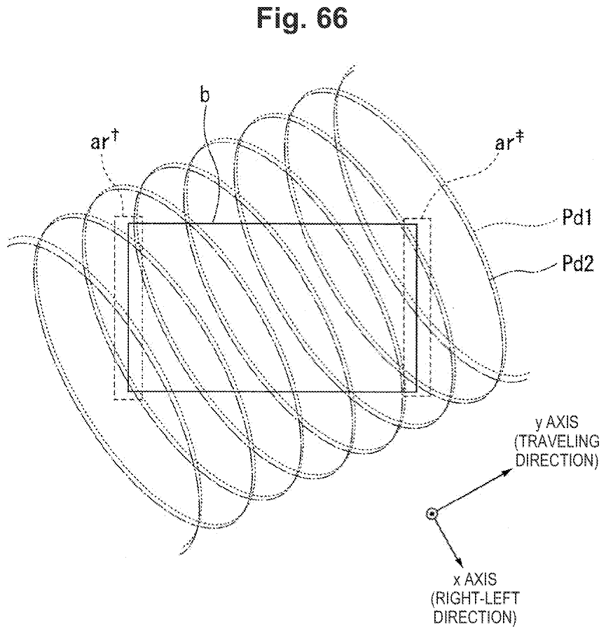

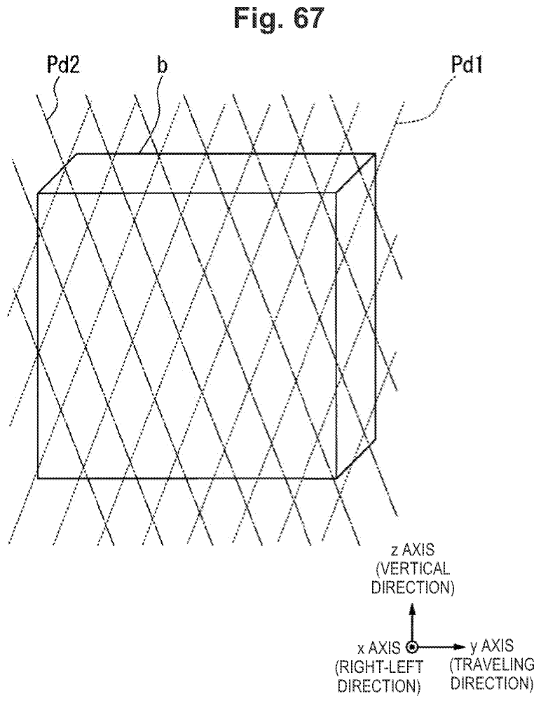

FIGS. 66 and 67 are each a schematic diagram for description of a measurement impossible region and a measurement low-accuracy region when the measurement object is a building. FIGS. 66 and 67 illustrate a horizontal view and a vertical cross-sectional view, respectively, of a building d and its surroundings, the building d existing in a space traveled by the vehicle 1 on which the MMS configured to measure surroundings of the road R is mounted.

FIGS. 66 and 67 each illustrate positional data acquisition positions Pd1 and positional data acquisition positions Pd2 as measurement targets when the vehicle 1 travels on the road R. As illustrated in FIG. 66, the emission direction of a laser beam emitted by the lidar Ls is in the negative direction along the x axis. Thus, in the case of the conventional technology as illustrated in FIGS. 20 and 21, the side surface of the building b on the left side is a blind spot when viewed from the position of the vehicle 1 passing by the building b. Accordingly, a measurement impossible region

a r^{†}
is generated on the side surface of the building b on the left side in the case of the conventional technology.

The side surface of the building b on the right side is a surface more nearly parallel to the emission direction of a laser beam than the side surface of the building b on the vehicle 1 side (the front side thereof when viewed from the position of the vehicle 1). Thus, in the case of the conventional technology as illustrated in FIGS. 20 and 21, the interval d4 of positional data acquisition positions Pa on the side surface of the building b on the right side is larger than the interval d3 of positional data acquisition positions Pa on the side surface of the building b on the vehicle 1 side (the road R side) (d4>d3). In other words, the measurement density decreases on the side surface of the building b on the right side. Accordingly, a measurement low-accuracy region

a r^{‡}
is generated on the side surface of the building b on the right side in the case of the conventional technology.

However, in the present embodiment, a measurement surface has an elevation angle or a depression angle as described above. Thus, the emission direction of a laser beam in a direction different from the height of the position of the lidar Ls includes a component in the traveling direction of the vehicle 1 or the direction opposite thereto (front or back direction along the y-axis direction). Accordingly, as illustrated in FIGS. 66 and 67, according to the present embodiment, a laser beam for each positional data acquisition position Pd1 and a laser beam for each positional data acquisition position Pd2 are incident on the measurement impossible region

a r^{†}
in the conventional technology. In this manner, according to the present embodiment, a laser beam is incident on the side surface (above-described measurement impossible region) of the building b on the left side, which is a blind spot in conventional cases when viewed from the position of the vehicle 1 passing by the building b, and thus the measurement impossible region is reduced as compared to conventional cases.

According to the present embodiment, when the shape of the building b on a horizontal plane (x-y plane) is a rectangle, it is possible to eliminate the measurement impossible region depending on the angle of installation of the building b on the road R. Such a case is, for example, a case in which the angle of each side surface of the building b with respect to the traveling direction of the vehicle 1 is an angle close to 45° and two measurement surfaces have large elevation and depression angles (in other words, the two measurement surfaces are close to the x-y plane). In this case, the emission direction of a laser beam includes a larger amount of a component in the traveling direction of the vehicle 1 (y-axis direction). Accordingly, a laser beam to the two measurement surfaces is incident on each of the four side surfaces of the building b.

According to the present embodiment, for example, when the shape of the building b on a horizontal plane (x-y plane) is a rhombus, a parallelogram, or the like and the longitudinal direction of the shape is close to the right-left direction of the vehicle 1 (x-axis direction), the probability that the measurement impossible region can be eliminated further increases.

Moreover, according to the present embodiment, since the emission direction of a laser beam includes a component in the traveling direction of the vehicle 1 or the direction opposite thereto (front or back direction along the y-axis direction), a laser beam to each positional data acquisition position Pd1 and a laser beam to each positional data acquisition position Pd2 are incident on the measurement low-accuracy region

a r^{‡}
in the conventional technology at a higher measurement density. In other words, according to the present embodiment, a laser beam is incident at a more nearly orthogonal angle on the side surface (above-described measurement low-accuracy region) of the building b on the right side, at which the measurement density is low in conventional cases because the side surface is positioned substantially in parallel to the right-left direction of the vehicle 1 (x-axis direction). In addition, according to the present embodiment, measurement is performed on a plurality of measurement surfaces having elevation and depression angles. Accordingly, the measurement density is increased and the measurement low-accuracy region is reduced as compared to the case of the conventional technology.

In the second embodiment described above, the measurement unit 101-3 performs measurement on two measurement surfaces having elevation and depression angles. However, the present invention is not limited to such a configuration, but for example, the measurement unit 101-3 may perform measurement on two measurement surfaces tilted in the right-left direction with respect to the traveling direction of the vehicle 1. In this case, effects same as effects by the MMS according to each of the first embodiment and the modification of the first embodiment described above can be obtained.

A lidar according to each embodiment described above may be built in an MMS or installed outside the MMS.

An MMS in each embodiment described above may be different from a device mounted on a movable body. For example, the MMS may be installed in a room and may acquire, through wireless communication or an easily removable storage medium, positional data measured by a measurement instrument (such as a lidar) included in the movable body. In this case, the measurement instrument is installed outside the MMS (in other words, on a movable body such as the vehicle 1).

The MMS in each embodiment described above may be achieved by a computer. In this case, a computer program for achieving functions of the MMS may be recorded in a computer-readable recording medium, and the computer program recorded in the recording medium may be read and executed by a computer system, thereby achieving the functions. The “computer system” includes an OS and a hardware component such as a peripheral instrument. The “computer-readable recording medium” is a portable medium such as a flexible disk, a magneto optical disc, a ROM, or a CD-ROM, or is a storage device such as a hard disk built in the computer system. The “computer-readable recording medium” may include a medium configured to dynamically hold the computer program for a short time, such as a communication wire for transmitting the computer program through a network such as the Internet or through a communication line such as a phone line, and may include a medium configured to hold the computer program for a certain time, such as a volatile memory inside the computer system, which serves as a server or a client in this case. The above-described computer program may achieve some of the above-described functions, and may achieve the above-described functions in combination with a computer program already recorded in the computer system. The above-described computer program may be achieved by using a programmable logic device such as a field programmable gate array (FPGA).

### REFERENCE SIGNS LIST

1 vehicle
10 MMS
101, 101-2, 101-3 measurement unit
102 storage unit
103 point group data generation unit
104 point group data output unit
201 motor
202 angle encoder
203, 203-1, 203-2 light projector
204, 204-1, 204-2 reflection mirror
205, 205-1, 205-2 light condensation lens
206, 206-1, 206-2 light receiver
207, 207-1, 207-2 stopwatch

1. A measurement device configured to move along a movement path and measure the position of an object in surroundings of the movement path, the measurement device comprising:
a measurement unit configured to measure the position of the object with a plurality of surfaces as measurement targets, the plurality of surfaces facing in directions different from each other;
a processor; and
a storage medium having computer program instructions stored thereon, when executed by the processor, perform to:
generate point group data of the object in surroundings of the movement path by using positional data representing the position of the object measured by the measurement unit.

2. The measurement device according to claim 1, wherein the measurement unit is installed at each of corners different from each other at a back part of a movable body moving along the movement path, and the measurement units perform measurement on the surfaces facing in directions different from each other, respectively.

3. The measurement device according to claim 2, wherein the measurement units are installed at right and left corners, respectively, among the corners at the back part of the movable body, the measurement unit installed at the left corner performs measurement on a surface tilted leftward with respect to a surface orthogonal to the traveling direction of the movable body, and the measurement unit installed at the right corner performs measurement on a surface tilted rightward with respect to the surface.

4. The measurement device according to claim 1, wherein the measurement unit measures the position of the object by emitting light and receiving reflected light that is the light reflected by the object.

5. The measurement device according to claim 4, wherein the measurement unit includes
a rotation mechanism configured to rotate at a constant speed,
a plurality of the light projectors that are rotated by the rotation mechanism and project the light at respective angles different from each other, and
a plurality of light reception units each configured to receive the reflected light of the light projected by the corresponding light projector.

6. The measurement device according to claim 4, wherein the measurement unit emits the light in respective directions different from each other at a constant interval by moving in a constant period and receives the reflected light of the emitted light.

7. The measurement device according to claim 6, wherein the measurement unit performs measurement on a surface having an elevation angle relative to a traveling direction, and a surface having a depression angle relative to the traveling direction.

8. A measurement method of moving along a movement path and measuring the position of an object in surroundings of the movement path, the measurement method comprising:
a measurement step of measuring the position of the object with a plurality of surfaces as measurement targets, the plurality of surfaces facing in directions different from each other; and
a point group data generation step of generating point group data of the object in surroundings of the movement path by using positional data representing the position of the object measured by the measurement step.
